(19) United States
(12) Patent Application Publication
(10) Pub. No.: US 2025/0062800 A1
(43) Pub. Date: Feb. 20, 2025

(54) HIGH-RESOLUTION CODEBOOK FOR DISTRIBUTED MIMO TRANSMISSION

(71) Applicant: Samsung Electronics Co., Ltd., Suwon-si (KR)

(72) Inventors: Gilwon Lee, McKinney, TX (US); Md. Saifur Rahman, Plano, TX (US); Eko Onggosanusi, Coppell, TX (US); Jeongho Jeon, San Jose, CA (US)

(21) Appl. No.: 18/927,570

(22) Filed: Oct. 25, 2024

Related U.S. Application Data
(63) Continuation of application No. 17/549,658, filed on Dec. 13, 2021, now abandoned.
(60) Provisional application No. 63/126,924, filed on Dec. 17, 2020.
(60) Provisional application No. 63/145,273, filed on Feb. 3, 2021.
(60) Provisional application No. 63/216,220, filed on Jun. 29, 2021.

(51) Int. Cl. H04B 7/0417; H04B 7/06

(52) U.S. Cl. CPC H04B 7/0417; H04B 7/0626; H04B 7/0634; H04B 7/0639

(57) ABSTRACT

A method for operating a user equipment (UE) comprises: receiving information associated with a channel state information (CSI) report, the information including a third-domain (TD) parameter N̅, where N̅>1; determining spatial domain (SD) basis vectors; determining frequency domain (FD) basis vectors; determining coefficients; wherein at least one of the SD basis vectors, the FD basis vectors, and the coefficients are determined independently for each dimension of the TD or determined jointly for all dimensions of the TD; and transmitting the CSI report including a precoding matrix indicator (PMI), the PMI indicating the SD basis vectors, the FD basis vectors, and the coefficients.

### CROSS-REFERENCE TO RELATED APPLICATIONS AND CLAIM OF PRIORITY

This application is a continuation of U.S. patent application Ser. No. 17/549,658, filed on Dec. 13, 2021, which claims priority to U.S. Provisional Patent Application No. 63/126,924, filed on Dec. 17, 2020; U.S. Provisional Patent Application No. 63/145,273, filed on Feb. 3, 2021; and U.S. Provisional Patent Application No. 63/216,220, filed on Jun. 29, 2021. The content of the above-identified patent documents is incorporated herein by reference.

### TECHNICAL FIELD

The present disclosure relates generally to wireless communication systems and more specifically to CSI reporting based on a codebook for distributed MIMO transmission.

### BACKGROUND

Understanding and correctly estimating the channel between a user equipment (UE) and a base station (BS) (e.g., gNode B (gNB)) is important for efficient and effective wireless communication. In order to correctly estimate the DL channel conditions, the gNB may transmit a reference signal, e.g., CSI-RS, to the UE for DL channel measurement, and the UE may report (e.g., feedback) information about channel measurement, e.g., CSI, to the gNB. With this DL channel measurement, the gNB is able to select appropriate communication parameters to efficiently and effectively perform wireless data communication with the UE.

### SUMMARY

Embodiments of the present disclosure provide methods and apparatuses to enable channel state information (CSI) reporting based on a codebook for distributed MIMO transmission in a wireless communication system.

In one embodiment, a UE for CSI reporting in a wireless communication system is provided. The UE includes a transceiver configured to receive information associated with a channel state information (CSI) report, the information including a third-domain (TD) parameter N̅, where N̅>1. The UE further includes a processor operably connected to the transceiver. The processor, based on the information, is configured to determine spatial domain (SD) basis vectors; determine frequency domain (FD) basis vectors; and determine coefficients; wherein at least one of the SD basis vectors, the FD basis vectors, and the coefficients are determined independently for each dimension of the TD or determined jointly for all dimensions of the TD. The transceiver is further configured to transmit the CSI report including a precoding matrix indicator (PMI), the PMI indicating the SD basis vectors, the FD basis vectors, and the coefficients.

In another embodiment, a BS in a wireless communication system is provided. The BS includes a processor configured to generate information associated with a channel state information (CSI) report, the information including a third-domain (TD) parameter N̅, where N̅>1. The BS further includes a transceiver operably connected to the processor. The transceiver is configured to: transmit the information; and receive the CSI report including a precoding matrix indicator (PMI), the PMI indicating spatial domain (SD) basis vectors, frequency domain (FD) basis vectors, and coefficients; wherein at least one of the SD basis vectors, the FD basis vectors, and the coefficients are based on each dimension of the TD or based on all dimensions of the TD.

In yet another embodiment, a method for operating a UE is provided. The method comprises: receiving information associated with a channel state information (CSI) report, the information including a third-domain (TD) parameter N̅, where N̅>1; determining spatial domain (SD) basis vectors; determining frequency domain (FD) basis vectors; determining coefficients; wherein at least one of the SD basis vectors, the FD basis vectors, and the coefficients are determined independently for each dimension of the TD or determined jointly for all dimensions of the TD; and transmitting the CSI report including a precoding matrix indicator (PMI), the PMI indicating the SD basis vectors, the FD basis vectors, and the coefficients.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4A illustrates a high-level diagram of an orthogonal frequency division multiple access transmit path according to embodiments of the present disclosure;

FIG. 4B illustrates a high-level diagram of an orthogonal frequency division multiple access receive path according to embodiments of the present disclosure;

FIG. 5 illustrates a transmitter block diagram for a PDSCH in a subframe according to embodiments of the present disclosure;

FIG. 6 illustrates a receiver block diagram for a PDSCH in a subframe according to embodiments of the present disclosure;

FIG. 7 illustrates a transmitter block diagram for a PUSCH in a subframe according to embodiments of the present disclosure;

FIG. 8 illustrates a receiver block diagram for a PUSCH in a subframe according to embodiments of the present disclosure;

FIG. 9 illustrates an example antenna blocks or arrays forming beams according to embodiments of the present disclosure;

FIG. 10 illustrates an example distributed MIMO (D-MIMO) system according to embodiments of the present disclosure;

FIG. 11 illustrates an example antenna port layout according to embodiments of the present disclosure;

FIG. 12 illustrates a 3D grid of oversampled DFT beams according to embodiments of the present disclosure;

FIG. 13 illustrates an example D-MIMO where each RRH has a single antenna panel according to embodiments of the present disclosure;

FIG. 14 illustrates an example D-MIMO where each RRH has multiple antenna panels according to embodiments of the present disclosure;

FIG. 15 illustrates an example D-MIMO where each RRH can have a single antenna panel or multiple antenna panels according to embodiments of the present disclosure;

FIG. 16 illustrates example codebooks for D-MIMO according to embodiments of the present disclosure;

FIG. 17 illustrates example decoupled and joint codebooks based on spatial- and frequency-domain compression according to embodiments of the present disclosure;

FIG. 18 illustrates an example D-MIMO system according to embodiments of the present disclosure;

FIG. 19 illustrates an example D-MIMO system according to embodiments of the present disclosure;

FIG. 20 illustrates an example of DL channels for single panel and multi-panel cases according to embodiments of the present disclosure;

FIG. 21 illustrates an example of compression using the SD/FD basis beams according to embodiments of the present disclosure;

FIG. 22 illustrates an example of restructuring to form a matrix over the FD-PD plane for each SD basis beam according to embodiments of the present disclosure;

FIG. 23 illustrates an example of restructuring to form a matrix over the SD-PD plane for each FD basis beam according to embodiments of the present disclosure;

FIG. 24 illustrates a flow chart of a method for operating a UE according to embodiments of the present disclosure; and

FIG. 25 illustrates a flow chart of a method for operating a BS according to embodiments of the present disclosure.

### DETAILED DESCRIPTION

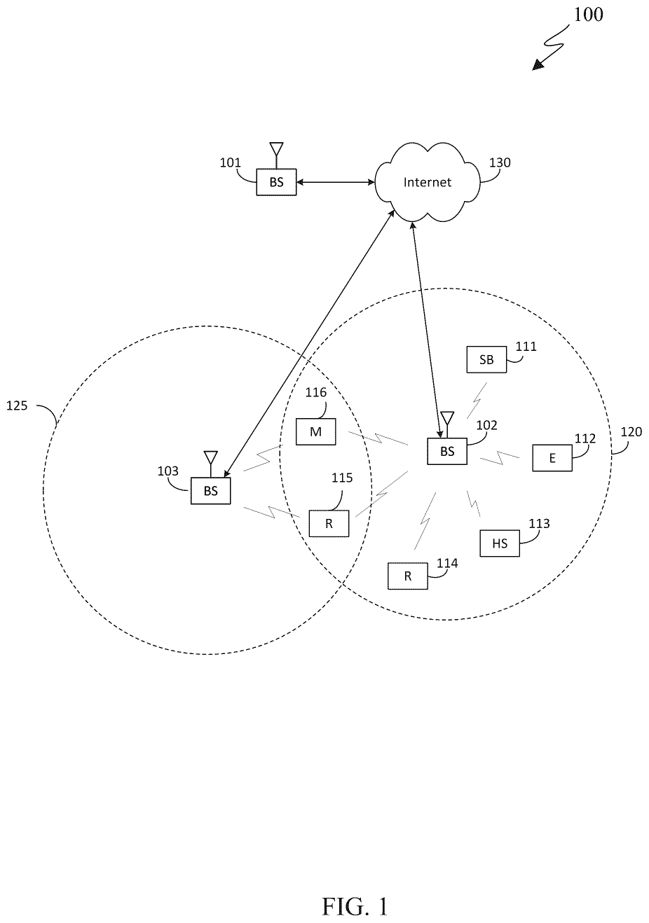

FIG. 1 through FIG. 25, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: 3GPP TS 36.211 v16.6.0, “E-UTRA, Physical channels and modulation” (herein “REF 1”); 3GPP TS 36.212 v16.6.0, “E-UTRA, Multiplexing and Channel coding” (herein “REF 2”); 3GPP TS 36.213 v16.6.0, “E-UTRA, Physical Layer Procedures” (herein “REF 3”); 3GPP TS 36.321 v16.6.0, “E-UTRA, Medium Access Control (MAC) protocol specification” (herein “REF 4”); 3GPP TS 36.331 v16.6.0, “E-UTRA, Radio Resource Control (RRC) protocol specification” (herein “REF 5”); 3GPP TR 22.891 v14.2.0 (herein “REF 6”); 3GPP TS 38.211 v16.6.0, “NR, Physical channels and modulation” (herein “REF 7”); 3GPP TS 38.212 v16.6.0, “E-UTRA, NR, Multiplexing and channel coding” (herein “REF 8”); 3GPP TS 38.213 v16.6.0, “NR, Physical Layer Procedures for Control” (herein “REF 9”); 3GPP TS 38.214 v16.6.0; “NR, Physical Layer Procedures for Data” (herein “REF 10”); 3GPP TS 38.215 v16.6.0, “NR, Physical Layer Measurements” (herein “REF 11”); 3GPP TS 38.321 v16.6.0, “NR, Medium Access Control (MAC) protocol specification” (herein “REF 12”); and 3GPP TS 38.331 v16.6.0, “NR, Radio Resource Control (RRC) Protocol Specification” (herein “REF 13”).

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, for brevity, both FDD and TDD are considered as the duplex method for both DL and UL signaling.

Although exemplary descriptions and embodiments to follow assume orthogonal frequency division multiplexing (OFDM) or orthogonal frequency division multiple access (OFDMA), the present disclosure can be extended to other OFDM-based transmission waveforms or multiple access schemes such as filtered OFDM (F-OFDM).

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4B below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system. The present disclosure covers several components which can be used in conjunction or in combination with one another, or can operate as standalone schemes.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, LTE, LTE-A, WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio interface/access (NR), long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for receiving information associated with a channel state information (CSI) report, the information including a third-domain (TD) parameter N̅, where N̅>1; determining spatial domain (SD) basis vectors; determining frequency domain (FD) basis vectors; determining coefficients; wherein at least one of the SD basis vectors, the FD basis vectors, and the coefficients are determined independently for each dimension of the TD or determined jointly for all dimensions of the TD; and transmitting the CSI report including a precoding matrix indicator (PMI), the PMI indicating the SD basis vectors, the FD basis vectors, and the coefficients. One or more of the gNBs 101-103 includes circuitry, programing, or a combination thereof, for generating information associated with a channel state information (CSI) report, the information including a third-domain (TD) parameter N̅, where N̅>1; transmitting the information; and receiving the CSI report including a precoding matrix indicator (PMI), the PMI indicating spatial domain (SD) basis vectors, frequency domain (FD) basis vectors, and coefficients; wherein at least one of the SD basis vectors, the FD basis vectors, and the coefficients are based on each dimension of the TD or based on all dimensions of the TD.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

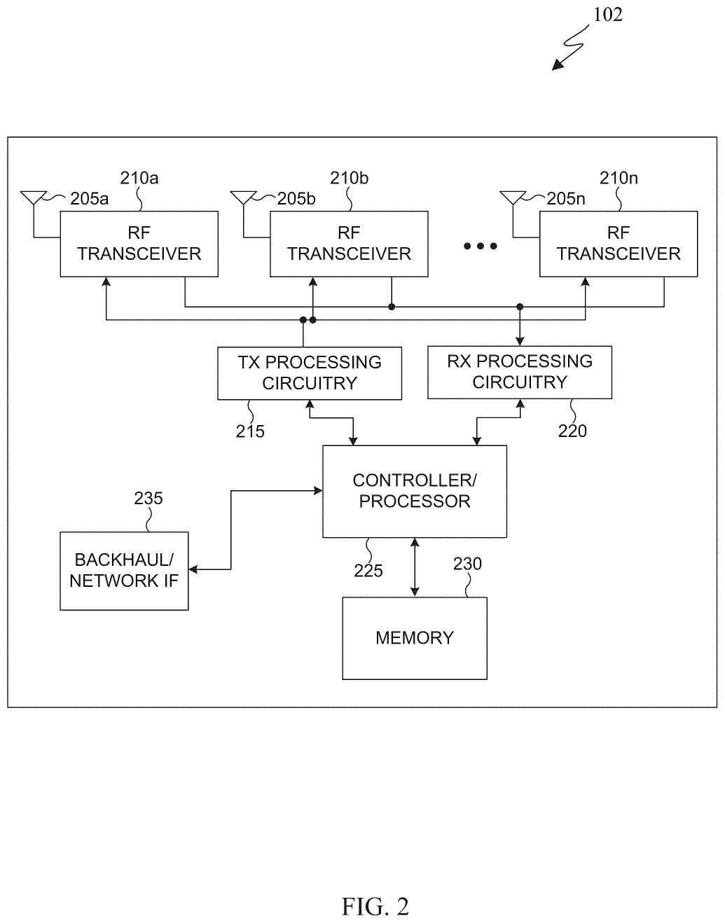

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions.

For instance, the controller/processor 225 could support beam forming or directional routing operations in which outgoing signals from multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

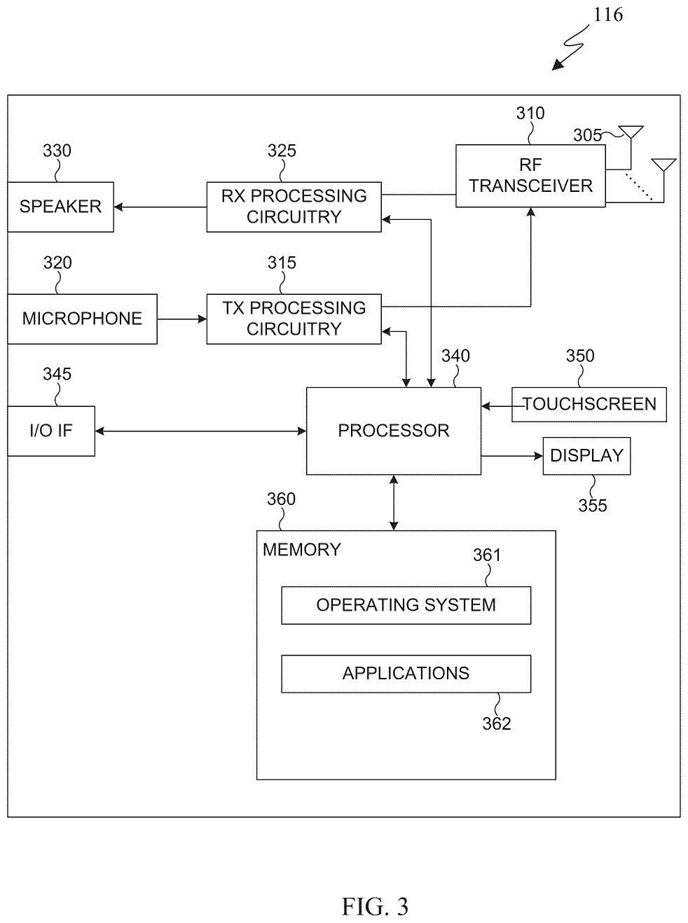

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for receiving information associated with a channel state information (CSI) report, the information including a third-domain (TD) parameter N̅, where N̅>1; determining spatial domain (SD) basis vectors; determining frequency domain (FD) basis vectors; determining coefficients; wherein at least one of the SD basis vectors, the FD basis vectors, and the coefficients are determined independently for each dimension of the TD or determined jointly for all dimensions of the TD; and transmitting the CSI report including a precoding matrix indicator (PMI), the PMI indicating the SD basis vectors, the FD basis vectors, and the coefficients. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

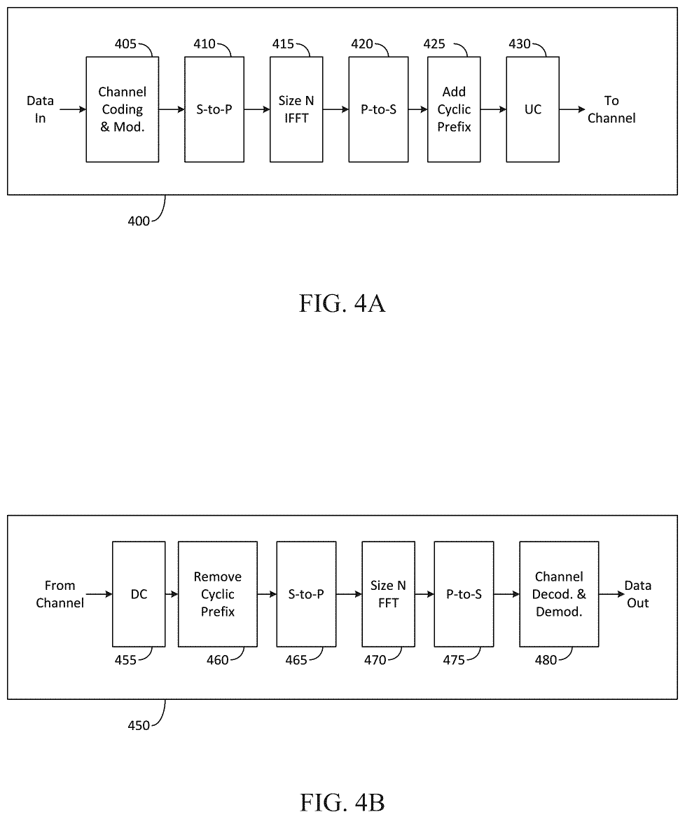

FIG. 4A is a high-level diagram of transmit path circuitry. For example, the transmit path circuitry may be used for an orthogonal frequency division multiple access (OFDMA) communication. FIG. 4B is a high-level diagram of receive path circuitry. For example, the receive path circuitry may be used for an orthogonal frequency division multiple access (OFDMA) communication. In FIGS. 4A and 4B, for downlink communication, the transmit path circuitry may be implemented in a base station (gNB) 102 or a relay station, and the receive path circuitry may be implemented in a user equipment (e.g., user equipment 116 of FIG. 1). In other examples, for uplink communication, the receive path circuitry 450 may be implemented in a base station (e.g., gNB 102 of FIG. 1) or a relay station, and the transmit path circuitry may be implemented in a user equipment (e.g., user equipment 116 of FIG. 1).

Transmit path circuitry comprises channel coding and modulation block 405, serial-to-parallel (S-to-P) block 410, Size N Inverse Fast Fourier Transform (IFFT) block 415, parallel-to-serial (P-to-S) block 420, add cyclic prefix block 425, and up-converter (UC) 430. Receive path circuitry 450 comprises down-converter (DC) 455, remove cyclic prefix block 460, serial-to-parallel (S-to-P) block 465, Size N Fast Fourier Transform (FFT) block 470, parallel-to-serial (P-to-S) block 475, and channel decoding and demodulation block 480.

At least some of the components in FIGS. 4A 400 and 4B 450 may be implemented in software, while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and may not be construed to limit the scope of the disclosure. It may be appreciated that in an alternate embodiment of the present disclosure, the Fast Fourier Transform functions and the Inverse Fast Fourier Transform functions may easily be replaced by discrete Fourier transform (DFT) functions and inverse discrete Fourier transform (IDFT) functions, respectively. It may be appreciated that for DFT and IDFT functions, the value of the N variable may be any integer number (i.e., 1, 4, 3, 4, etc.), while for FFT and IFFT functions, the value of the N variable may be any integer number that is a power of two (i.e., 1, 2, 4, 8, 16, etc.).

In transmit path circuitry 400, channel coding and modulation block 405 receives a set of information bits, applies coding (e.g., LDPC coding) and modulates (e.g., quadrature phase shift keying (QPSK) or quadrature amplitude modulation (QAM)) the input bits to produce a sequence of frequency-domain modulation symbols. Serial-to-parallel block 410 converts (i.e., de-multiplexes) the serial modulated symbols to parallel data to produce N parallel symbol streams where N is the IFFT/FFT size used in BS 102 and UE 116. Size N IFFT block 415 then performs an IFFT operation on the N parallel symbol streams to produce time-domain output signals. Parallel-to-serial block 420 converts (i.e., multiplexes) the parallel time-domain output symbols from Size N IFFT block 415 to produce a serial time-domain signal. Add cyclic prefix block 425 then inserts a cyclic prefix to the time-domain signal. Finally, up-converter 430 modulates (i.e., up-converts) the output of add cyclic prefix block 425 to RF frequency for transmission via a wireless channel. The signal may also be filtered at baseband before conversion to RF frequency.

The transmitted RF signal arrives at the UE 116 after passing through the wireless channel, and reverse operations to those at gNB 102 are performed. Down-converter 455 down-converts the received signal to baseband frequency and removes cyclic prefix block 460, and removes the cyclic prefix to produce the serial time-domain baseband signal. Serial-to-parallel block 465 converts the time-domain baseband signal to parallel time-domain signals. Size N FFT block 470 then performs an FFT algorithm to produce N parallel frequency-domain signals. Parallel-to-serial block 475 converts the parallel frequency-domain signals to a sequence of modulated data symbols. Channel decoding and demodulation block 480 demodulates and then decodes the modulated symbols to recover the original input data stream.

Each of gNBs 101-103 may implement a transmit path that is analogous to transmitting in the downlink to user equipment 111-116 and may implement a receive path that is analogous to receiving in the uplink from user equipment 111-116. Similarly, each one of user equipment 111-116 may implement a transmit path corresponding to the architecture for transmitting in the uplink to gNBs 101-103 and may implement a receive path corresponding to the architecture for receiving in the downlink from gNBs 101-103.

A communication system includes a downlink (DL) that conveys signals from transmission points such as base stations (BSs) or NodeBs to user equipments (UEs) and an Uplink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE system, DL signals can include data signals conveying information content, control signals conveying DL control information (DCI), and reference signals (RS) that are also known as pilot signals. An eNodeB transmits data information through a physical DL shared channel (PDSCH). An eNodeB transmits DCI through a physical DL control channel (PDCCH) or an Enhanced PDCCH (EPDCCH).

An eNodeB transmits acknowledgement information in response to data transport block (TB) transmission from a UE in a physical hybrid ARQ indicator channel (PHICH). An eNodeB transmits one or more of multiple types of RS including a UE-common RS (CRS), a channel state information RS (CSI-RS), or a demodulation RS (DMRS). A CRS is transmitted over a DL system bandwidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe and can have, for example, duration of 1 millisecond.

DL signals also include transmission of a logical channel that carries system control information. A BCCH is mapped to either a transport channel referred to as a broadcast channel (BCH) when the DL signals convey a master information block (MIB) or to a DL shared channel (DL-SCH) when the DL signals convey a System Information Block (SIB). Most system information is included in different SIBs that are transmitted using DL-SCH. A presence of system information on a DL-SCH in a subframe can be indicated by a transmission of a corresponding PDCCH conveying a codeword with a cyclic redundancy check (CRC) scrambled with system information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe and a group of physical resource blocks (PRBs). A transmission BW includes frequency resource units referred to as resource blocks (RBs). Each RB includes N_{sc}^{RB} sub-carriers, or resource elements (REs), such as 12 REs. A unit of one RB over one subframe is referred to as a PRB. A UE can be allocated M_{PDSCH} RBs for a total of M_{sc}^{PDSCH}=M_{PDSCH}·N_{sc}^{RB} REs for the PDSCH transmission BW.

UL signals can include data signals conveying data information, control signals conveying UL control information (UCI), and UL RS. UL RS includes DMRS and Sounding RS (SRS). A UE transmits DMRS only in a BW of a respective PUSCH or PUCCH. An eNodeB can use a DMRS to demodulate data signals or UCI signals. A UE transmits SRS to provide an eNodeB with an UL CSI. A UE transmits data information or UCI through a respective physical UL shared channel (PUSCH) or a Physical UL control channel (PUCCH). If a UE needs to transmit data information and UCI in a same UL subframe, the UE may multiplex both in a PUSCH. UCI includes Hybrid Automatic Repeat request acknowledgement (HARQ-ACK) information, indicating correct (ACK) or incorrect (NACK) detection for a data TB in a PDSCH or absence of a PDCCH detection (DTX), scheduling request (SR) indicating whether a UE has data in the UE's buffer, rank indicator (RI), and channel state information (CSI) enabling an eNodeB to perform link adaptation for PDSCH transmissions to a UE. HARQ-ACK information is also transmitted by a UE in response to a detection of a PDCCH/EPDCCH indicating a release of semi-persistently scheduled PDSCH.

An UL subframe (or slot) includes two slots. Each slot includes N_{symb}^{UL} symbols for transmitting data information, UCI, DMRS, or SRS. A frequency resource unit of an UL system BW is a RB. A UE is allocated N_{RB} RBs for a total of N_{RB}·N_{sc}^{RB} REs for a transmission BW. For a PUCCH, N_{RB}=1. A last subframe symbol can be used to multiplex SRS transmissions from one or more UEs. A number of subframe symbols that are available for data/UCI/DMRS transmission is N_{symb}=2·(N_{symb}^{UL}−1)−N_{SRS}, where N_{SRS}=1 if a last subframe symbol is used to transmit SRS and N_{SRS}=0 otherwise.

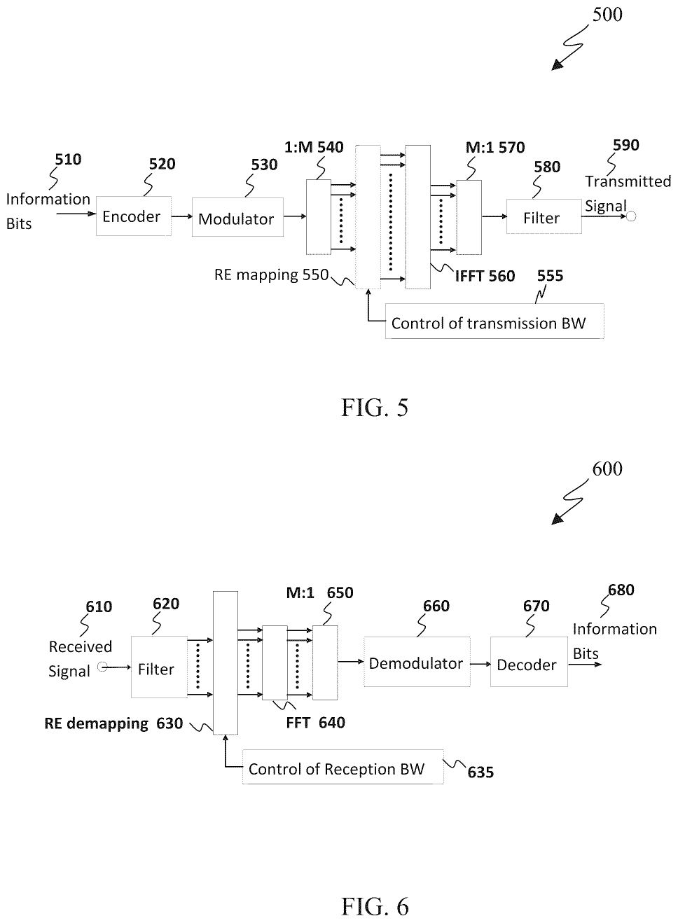

FIG. 5 illustrates a transmitter block diagram 500 for a PDSCH in a subframe according to embodiments of the present disclosure. The embodiment of the transmitter block diagram 500 illustrated in FIG. 5 is for illustration only. One or more of the components illustrated in FIG. 5 can be implemented in specialized circuitry configured to perform the noted functions or one or more of the components can be implemented by one or more processors executing instructions to perform the noted functions. FIG. 5 does not limit the scope of this disclosure to any particular implementation of the transmitter block diagram 500.

As shown in FIG. 5, information bits 510 are encoded by encoder 520, such as a turbo encoder, and modulated by modulator 530, for example using quadrature phase shift keying (QPSK) modulation. A serial to parallel (S/P) converter 540 generates M modulation symbols that are subsequently provided to a mapper 550 to be mapped to REs selected by a transmission BW selection unit 555 for an assigned PDSCH transmission BW, unit 560 applies an Inverse fast Fourier transform (IFFT), the output is then serialized by a parallel to serial (P/S) converter 570 to create a time domain signal, filtering is applied by filter 580, and a signal transmitted 590. Additional functionalities, such as data scrambling, cyclic prefix insertion, time windowing, interleaving, and others are well known in the art and are not shown for brevity.

FIG. 6 illustrates a receiver block diagram 600 for a PDSCH in a subframe according to embodiments of the present disclosure. The embodiment of the diagram 600 illustrated in FIG. 6 is for illustration only. One or more of the components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the diagram 600.

As shown in FIG. 6, a received signal 610 is filtered by filter 620, REs 630 for an assigned reception BW are selected by BW selector 635, unit 640 applies a fast Fourier transform (FFT), and an output is serialized by a parallel-to-serial converter 650. Subsequently, a demodulator 660 coherently demodulates data symbols by applying a channel estimate obtained from a DMRS or a CRS (not shown), and a decoder 670, such as a turbo decoder, decodes the demodulated data to provide an estimate of the information data bits 680. Additional functionalities such as time-windowing, cyclic prefix removal, de-scrambling, channel estimation, and de-interleaving are not shown for brevity.

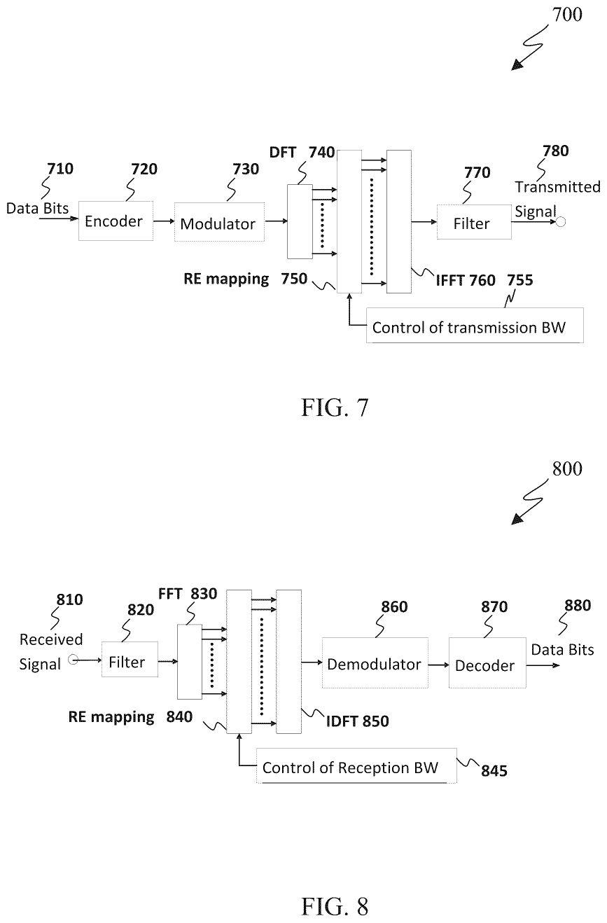

FIG. 7 illustrates a transmitter block diagram 700 for a PUSCH in a subframe according to embodiments of the present disclosure. The embodiment of the block diagram 700 illustrated in FIG. 7 is for illustration only. One or more of the components illustrated in FIG. 5 can be implemented in specialized circuitry configured to perform the noted functions or one or more of the components can be implemented by one or more processors executing instructions to perform the noted functions. FIG. 7 does not limit the scope of this disclosure to any particular implementation of the block diagram 700.

As shown in FIG. 7, information data bits 710 are encoded by encoder 720, such as a turbo encoder, and modulated by modulator 730. A discrete Fourier transform (DFT) unit 740 applies a DFT on the modulated data bits, REs 750 corresponding to an assigned PUSCH transmission BW are selected by transmission BW selection unit 755, unit 760 applies an IFFT and, after a cyclic prefix insertion (not shown), filtering is applied by filter 770 and a signal transmitted 780.

FIG. 8 illustrates a receiver block diagram 800 for a PUSCH in a subframe according to embodiments of the present disclosure. The embodiment of the block diagram 800 illustrated in FIG. 8 is for illustration only. One or more of the components illustrated in FIG. 8 can be implemented in specialized circuitry configured to perform the noted functions or one or more of the components can be implemented by one or more processors executing instructions to perform the noted functions. FIG. 8 does not limit the scope of this disclosure to any particular implementation of the block diagram 800.

As shown in FIG. 8, a received signal 810 is filtered by filter 820. Subsequently, after a cyclic prefix is removed (not shown), unit 830 applies a FFT, REs 840 corresponding to an assigned PUSCH reception BW are selected by a reception BW selector 845, unit 850 applies an inverse DFT (IDFT), a demodulator 860 coherently demodulates data symbols by applying a channel estimate obtained from a DMRS (not shown), a decoder 870, such as a turbo decoder, decodes the demodulated data to provide an estimate of the information data bits 880.

In next generation cellular systems, various use cases are envisioned beyond the capabilities of LTE system. Termed 5G or the fifth generation cellular system, a system capable of operating at sub-6 GHZ and above-6 GHz (for example, in mmWave regime) becomes one of the requirements. In 3GPP TR 22.891, 74 5G use cases have been identified and described; those use cases can be roughly categorized into three different groups. A first group is termed “enhanced mobile broadband (eMBB),” targeted to high data rate services with less stringent latency and reliability requirements. A second group is termed “ultra-reliable and low latency (URLL)” targeted for applications with less stringent data rate requirements, but less tolerant to latency. A third group is termed “massive MTC (mMTC)” targeted for large number of low-power device connections such as 1 million per km² with less stringent the reliability, data rate, and latency requirements.

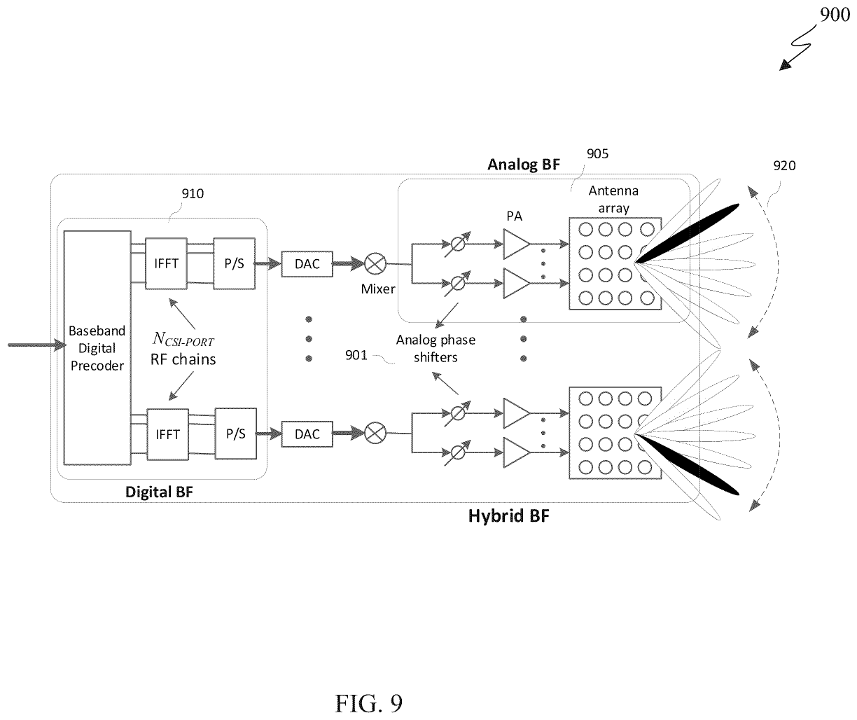

FIG. 9 illustrates an example antenna blocks or arrays 900 according to embodiments of the present disclosure. The embodiment of the antenna blocks or arrays 900 illustrated in FIG. 9 is for illustration only. FIG. 9 does not limit the scope of this disclosure to any particular implementation of the antenna blocks or arrays 900.

For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 9. In this case, one CSI-RS port is mapped onto a large number of antenna elements which can be controlled by a bank of analog phase shifters 901. One CSI-RS port can then correspond to one sub-array which produces a narrow analog beam through analog beamforming 905. This analog beam can be configured to sweep across a wider range of angles (920) by varying the phase shifter bank across symbols or subframes. The number of sub-arrays (equal to the number of RF chains) is the same as the number of CSI-RS ports N_{CSI-PORT}. A digital beamforming unit 910 performs a linear combination across N_{CSI-PORT} analog beams to further increase precoding gain. While analog beams are wideband (hence not frequency-selective), digital precoding can be varied across frequency sub-bands or resource blocks.

To enable digital precoding, efficient design of CSI-RS is a crucial factor. For this reason, three types of CSI reporting mechanisms corresponding to three types of CSI-RS measurement behavior are supported, for example, “CLASS A” CSI reporting which corresponds to non-precoded CSI-RS, “CLASS B” reporting with K=1 CSI-RS resource which corresponds to UE-specific beamformed CSI-RS, and “CLASS B” reporting with K>1 CSI-RS resources which corresponds to cell-specific beamformed CSI-RS.

For non-precoded (NP) CSI-RS, a cell-specific one-to-one mapping between CSI-RS port and TXRU is utilized. Different CSI-RS ports have the same wide beam width and direction and hence generally cell wide coverage. For beamformed CSI-RS, beamforming operation, either cell-specific or UE-specific, is applied on a non-zero-power (NZP) CSI-RS resource (e.g., comprising multiple ports). At least at a given time/frequency, CSI-RS ports have narrow beam widths and hence not cell wide coverage, and at least from the gNB perspective. At least some CSI-RS port-resource combinations have different beam directions.

In scenarios where DL long-term channel statistics can be measured through UL signals at a serving eNodeB, UE-specific BF CSI-RS can be readily used. This is typically feasible when UL-DL duplex distance is sufficiently small. When this condition does not hold, however, some UE feedback is necessary for the eNodeB to obtain an estimate of DL long-term channel statistics (or any of representation thereof). To facilitate such a procedure, a first BF CSI-RS transmitted with periodicity T1 (ms) and a second NP CSI-RS transmitted with periodicity T2 (ms), where T1≤T2. This approach is termed hybrid CSI-RS. The implementation of hybrid CSI-RS is largely dependent on the definition of CSI process and NZP CSI-RS resource.

In a wireless communication system, MIMO is often identified as an essential feature in order to achieve high system throughput requirements. One of the key components of a MIMO transmission scheme is the accurate CSI acquisition at the eNB (or gNB) (or TRP). For MU-MIMO, in particular, the availability of accurate CSI is necessary in order to guarantee high MU performance. For TDD systems, the CSI can be acquired using the SRS transmission relying on the channel reciprocity. For FDD systems, on the other hand, it can be acquired using the CSI-RS transmission from eNB (or gNB), and CSI acquisition and feedback from UE. In legacy FDD systems, the CSI feedback framework is ‘implicit’ in the form of CQI/PMI/RI (also CRI and LI) derived from a codebook assuming SU transmission from eNB (or gNB). Because of the inherent SU assumption while deriving CSI, this implicit CSI feedback is inadequate for MU transmission. Since future (e.g., NR) systems are likely to be more MU-centric, this SU-MU CSI mismatch will be a bottleneck in achieving high MU performance gains. Another issue with implicit feedback is the scalability with larger number of antenna ports at eNB (or gNB). For large number of antenna ports, the codebook design for implicit feedback is quite complicated (for example, a total number of 44 Class A codebooks in the 3GPP LTE specification), and the designed codebook is not guaranteed to bring justifiable performance benefits in practical deployment scenarios (for example, only a small percentage gain can be shown at the most). Realizing aforementioned issues, the 3GPP specification also supports advanced CSI reporting in LTE.

In 5G or NR systems [REF7, REF8], the above-mentioned “implicit” CSI reporting paradigm from LTE is also supported and referred to as Type I CSI reporting. In addition, a high-resolution CSI reporting, referred to as Type II CSI reporting, is also supported to provide more accurate CSI information to gNB for use cases such as high-order MU-MIMO. However, the overhead of Type II CSI reporting can be an issue in practical UE implementations. One approach to reduce Type II CSI overhead is based on frequency domain (FD) compression. In Rel. 16 NR, DFT-based FD compression of the Type II CSI has been supported (referred to as Rel. 16 enhanced Type II codebook in REF8). Some of the key components for this feature includes (a) spatial domain (SD) basis W₁, (b) FD basis W_{f}, and (c) coefficients \tilde{W}₂ that linearly combine SD and FD basis. In a non-reciprocal FDD system, a complete CSI (comprising all components) needs to be reported by the UE. However, when reciprocity or partial reciprocity does exist between UL and DL, then some of the CSI components can be obtained based on the UL channel estimated using SRS transmission from the UE. In Rel. 16 NR, the DFT-based FD compression is extended to this partial reciprocity case (referred to as Rel. 16 enhanced Type II port selection codebook in REF8), wherein the DFT-based SD basis in W₁ is replaced with SD CSI-RS port selection, i.e., L out of

$$\frac{{P}_{CSI - RS}}{2}$$

CSI-RS ports are selected (the selection is common for the two antenna polarizations or two halves of the CSI-RS ports). The CSI-RS ports in this case are beamformed in SD (assuming UL-DL channel reciprocity in angular domain), and the beamforming information can be obtained at the gNB based on UL channel estimated using SRS measurements.

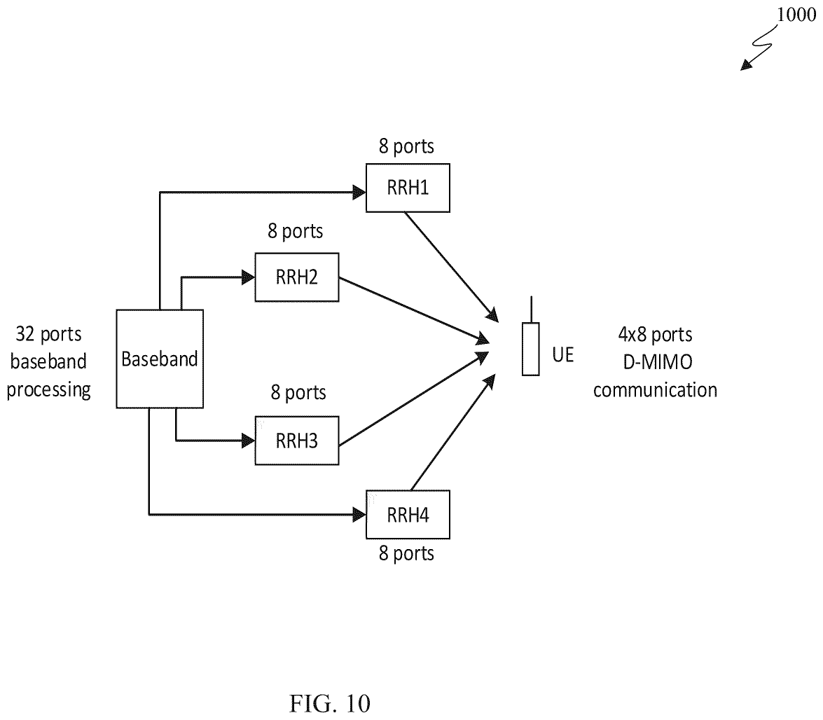

FIG. 10 illustrates an example distributed MIMO (D-MIMO) system 1000 according to embodiments of the present disclosure. The embodiment of the distributed MIMO (D-MIMO) system 1000 illustrated in FIG. 10 is for illustration only. FIG. 10 does not limit the scope of this disclosure to any particular implementation of the distributed MIMO (D-MIMO) system 1000.

NR supports up to 32 CSI-RS antenna ports. For a cellular system operating in a sub-1 GHz frequency range (e.g., less than 1 GHz), supporting a large number of CSI-RS antenna ports (e.g., 32) at one site or remote radio head (RRH) is challenging due to larger antenna form factors at these frequencies (when compared with a system operating at a higher frequency such as 2 GHz or 4 GHz). At such low frequencies, the maximum number of CSI-RS antenna ports that can be co-located at a site (or RRH) can be limited, for example to 8. This limits the spectral efficiency of such systems. In particular, the MU-MIMO spatial multiplexing gains offered due to large number of CSI-RS antenna ports (such as 32) can't be achieved. One way to operate a sub-1 GHz system with large number of CSI-RS antenna ports is based on distributing antenna ports at multiple sites (or RRHs). The multiple sites or RRHs can still be connected to a single (common) baseband unit, hence the signal transmitted/received via multiple distributed RRHs can still be processed at a centralized location. For example, 32 CSI-RS ports can be distributed across 4 RRHs, each with 8 antenna ports. Such a MIMO system can be referred to as a distributed MIMO (D-MIMO) system as illustrated in FIG. 10. Although the terminology RRH is used, other terminologies can be used instead of RRH, for example, TRP, distributed unit (DU), remote unit (RU), access point (AP), and so on.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can consist of one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include all the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for all the Mₙ subbands within the CSI reporting band. A CSI parameter is configured with “subband” for the CSI reporting band with Mₙ subbands when one CSI parameter is reported for each of the Mₙ subbands within the CSI reporting band.

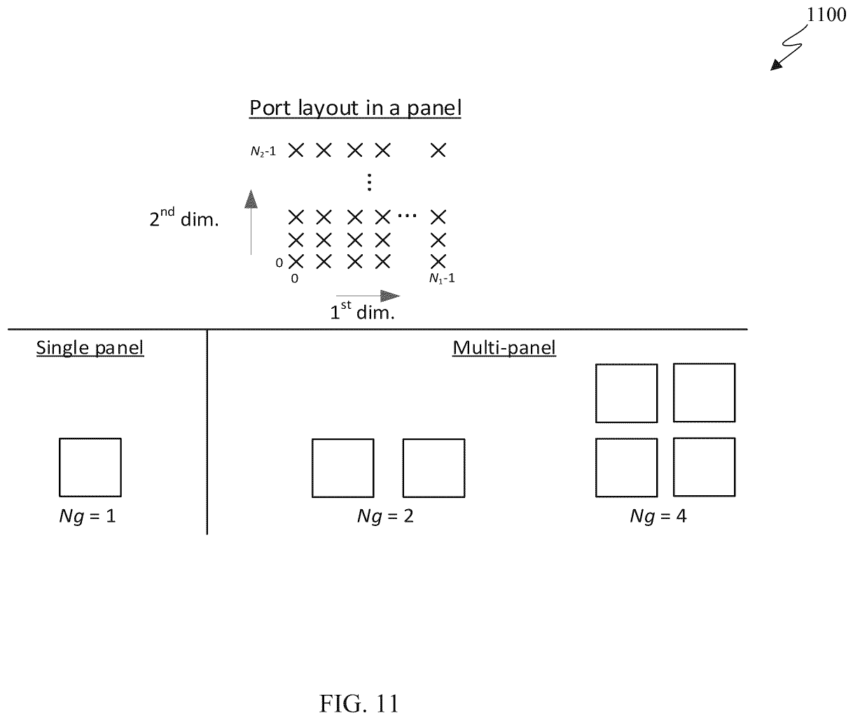

FIG. 11 illustrates an example antenna port layout 1100 according to embodiments of the present disclosure. The embodiment of the antenna port layout 1100 illustrated in FIG. 11 is for illustration only. FIG. 11 does not limit the scope of this disclosure to any particular implementation of the antenna port layout 1100.

As illustrated in FIGS. 11, N₁ and N₂ are the number of antenna ports with the same polarization in the first and second dimensions, respectively. For 2D antenna port layouts, N₁>1, N₂>1, and for 1D antenna port layouts N₁>1 and N₂=1. Therefore, for a dual-polarized antenna port layout, the total number of antenna ports is 2N₁N₂ when each antenna maps to an antenna port. An illustration is shown in FIG. 11 where “X” represents two antenna polarizations. In this disclosure, the term “polarization” refers to a group of antenna ports. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-Rs antenna ports and X is a starting antenna port number (e.g., X=3000, then antenna ports are 3000, 3001, 3002, . . . ).

Let N_{g} be a number of antenna panels at the gNB. When there are multiple antenna panels (N_{g}>1), we assume that each panel is dual-polarized antenna ports with N₁ and N₂ ports in two dimensions. This is illustrated in FIG. 11. Note that the antenna port layouts may or may not be the same in different antenna panels.

As described in Section 5.2.2.2.3 of [REF 9], the Type II single-panel codebook has the following rank 1 (1-layer) pre-coder structure:

$${W}_{{q}_{1} , {q}_{2} , {n}_{1} , {n}_{2} , {p}_{l}^{( 1 )} , {p}_{l}^{( 2 )} , {c}_{l}}^{l} = \frac{1}{\sqrt{{N}_{1} {N}_{2} {\sum }_{i = 0}^{2 L - 1} {( {p}_{l , i}^{( 1 )} {p}_{l , i}^{( 2 )} )}^{2}}} [ \begin{matrix}{\sum }_{i = 0}^{L - 1} {v}_{{m}_{1}^{( i )} , {m}_{2}^{( i )}} {p}_{l , i}^{( 1 )} {p}_{l , i}^{( 2 )} {φ}_{l , i} \\ {\sum }_{i = 0}^{L - 1} {v}_{{m}_{1}^{( i )} , {m}_{2}^{( i )}} {p}_{l , i + L}^{( 1 )} {p}_{l , i + L}^{( 2 )} {φ}_{l , i + L}\end{matrix} ] , l = 1$$

where p_{l,i}⁽¹⁾ are p_{l,i}⁽²⁾ amplitude coefficients, and φ_{l,i} is a phase coefficient, and vₘ_{₁}_{⁽ⁱ⁾}_{,m}_{₂}_{⁽ⁱ⁾} where i=0,1, . . . , L−1 are L beams comprising W₁ with beam indices m₁⁽ⁱ⁾, m₂⁽ⁱ⁾, and

$${u}_{m} = \{ \begin{matrix}[ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}} ]}\end{matrix} & {N}_{2} > 1 \\ 1 & {N}_{2} = 1\end{matrix}$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T}$$

is a two-dimensional DFT vector. The supported values of φ_{l,i} corresponds to QPSK or 8-PSK (configurable). The supported values of (N₁, N₂, O₁, O₂) is given by Table 1.

TABLE 1
Supported configurations
of (N₁, N₂) and (O₁, O₂)

| Number of | | |
|---|---|---|
| CSI-RS antenna | | |
| ports, P_{CSI-RS} | (N₁, N₂) | (O₁, O₂) |
| 4 | (2, 1) | (4, 1) |
| 8 | (2, 2) | (4, 4) |
| | (4, 1) | (4,1) |
| 12 | (3, 2) | (4, 4) |
| | (6, 1) | (4, 1) |
| 16 | (4, 2) | (4, 4) |
| | (8, 1) | (4, 1) |
| 24 | (4, 3) | (4, 4) |
| | (6, 2) | (4, 4) |
| | (12, 1) | (4, 1) |
| 32 | (4, 4) | (4, 4) |
| | (8, 2) | (4, 4) |
| | (16, 1) | (4, 1) |

The supported values of p_{l,i}⁽¹⁾ and p_{l,i}⁽²⁾ are according to Table 2 and Table 3, respectively. The reporting of amplitude component p_{l,i}⁽²⁾ can be configurable (ON/OFF).

TABLE 2
amplitude codebook
for p_{l,i}⁽¹⁾

| k_{l,i}⁽¹⁾ | p_{l,i}⁽¹⁾ |
|---|---|
| 0 | 0 |
| 1 | \sqrt{1/64} |
| 2 | \sqrt{1/32} |
| 3 | \sqrt{1/16} |
| 4 | \sqrt{1/8} |
| 5 | \sqrt{1/4} |
| 6 | \sqrt{1/2} |
| 7 | 1 |

TABLE 3
amplitude codebook
for p_{l,i}⁽²⁾

| k_{l,i}⁽²⁾ | p_{l,i}⁽²⁾ |
|---|---|
| 0 | \sqrt{1/2} |
| 1 | 1 |

As described in Section 5.2.2.2.4 of [REF 9], the Type II port selection codebook has the following rank 1 (1-layer) pre-coder structure:

$${W}_{{i}_{1 , 1} , {p}_{l}^{( 1 )} , {p}_{l}^{( 2 )} , {c}_{l}}^{l} = \frac{1}{\sqrt{{\sum }_{i = 0}^{2 L - 1} {( {p}_{l , i}^{( 1 )} {p}_{l , i}^{( 2 )} )}^{2}}} [ \begin{matrix}{\sum }_{i = 0}^{L - 1} {v}_{{i}_{1 , 1} d + 1} {p}_{l , i}^{( 1 )} {p}_{l , i}^{( 2 )} {φ}_{l , i} \\ {{\sum }^{L - 1}}_{i = 0} {v}_{{i}_{1 , 1} d + 1} {p}_{l , i + L}^{( 1 )} {p}_{l , i + L}^{( 2 )} {φ}_{l , i + L}\end{matrix} ] ,$$

$$l = 1$$

where vₘ is a P_{CSI-RS}/2-element column vector containing a value of 1 in element

$$( m mod \frac{{P}_{CSI - RS}}{2} )$$

and zeros elsewhere (where the first element is element 0). The value of d is configured with the higher layer parameter portSelectionSamplingSize, where d ∈ {1,2,3,4} and

$$d \leq min ( \frac{{P}_{CSI - RS}}{2} , L ) .$$

The rest of the details are the same as in Section 5.2.2.2.3 of [REF8].

As described in U.S. Pat. No. 10,659,118, issued May 19, 2020 and entitled “Method and Apparatus for Explicit CSI Reporting in Advanced Wireless Communication Systems,” which is incorporated herein by reference in its entirety, a UE is configured with high-resolution (e.g., Type II) CSI reporting in which the linear combination based Type II CSI reporting framework is extended to include a frequency dimension in addition to the first and second antenna port dimensions.

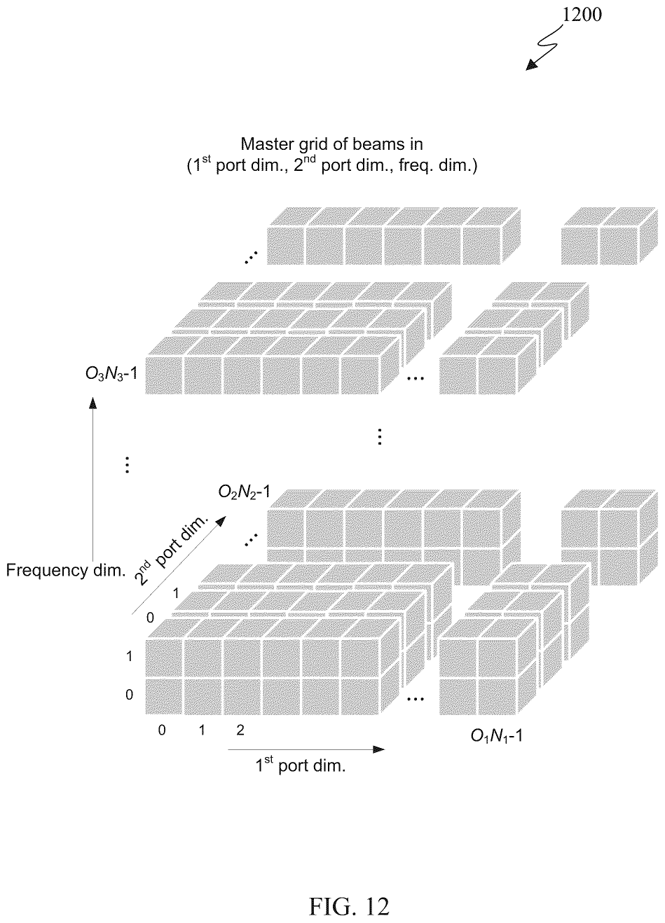

FIG. 12 illustrates a 3D grid 1100 of the oversampled DFT beams (1st port dim., 2nd port dim., freq. dim.) in which
1st dimension is associated with the 1st port dimension,
2nd dimension is associated with the 2nd port dimension, and
3rd dimension is associated with the frequency dimension.

The basis sets for 1^{st} and 2^{nd} port domain representation are oversampled DFT codebooks of length-N₁ and length-N₂, respectively, and with oversampling factors O₁ and O₂, respectively. Likewise, the basis set for frequency domain representation (i.e., 3rd dimension) is an oversampled DFT codebook of length-N₃ and with oversampling factor O₃. In one example, O₁=O²=O₃=₄. In another example, the oversampling factors Oᵢ belongs to {2, 4, 8}. In yet another example, at least one of O₁, O₂, and O₃ is higher layer configured (via RRC signaling).

As explained in Section 5.2.2.2.5 and 5.2.2.2.6 of REF8, a UE is configured with higher layer parameter codebookType set to ‘typeII-PortSelection-r16’ for an enhanced Type II CSI reporting in which the pre-coders for all SBs and for a given layer l=1, . . . , v, where v is the associated RI value, is given by either

$${W}^{l} = A {C}_{l} {B}^{H} = [ {a}_{0} {a}_{1} … {a}_{L - 1} ] [ \begin{matrix}{c}_{l , 0 , 0} & {c}_{l , 0 , 1} & ⋯ & {c}_{l , 0 , M - 1} \\ {c}_{l , 1 , 0} & {c}_{l , 1 , 1} & ⋯ & {c}_{l , 1 , M - 1} \\ ⋮ & ⋮ & ⋮ & ⋮ \\ {c}_{l , L - 1 , 0} & {c}_{l , L - 1 , 1} & ⋯ & {c}_{l , L - 1 , M - 1}\end{matrix} ] {[ {b}_{0} {b}_{1} … {b}_{M - 1} ]}^{H} = {\sum }_{f = 0}^{M - 1} {\sum }_{i = 0}^{L - 1} {c}_{l , i , f} ( {a}_{i} {b}_{f}^{H} ) = {\sum }_{i = 0}^{L - 1} {\sum }_{f = 0}^{M - 1} {c}_{l , i , f} ( {a}_{i} {b}_{f}^{H} ) , \qquad ( Eq . 1 )$$

$$or$$

$${W}^{l} = [ \begin{matrix}A & 0 \\ 0 & A\end{matrix} ] {C}_{l} {B}^{H} = [ \begin{matrix}{a}_{0} {a}_{1} … {a}_{L - 1} & 0 \\ 0 & {a}_{0} {a}_{1} … {a}_{L - 1}\end{matrix} ] [ \begin{matrix}{c}_{l , 0 , 0} & {c}_{l , 0 , 1} & ⋯ & {c}_{l , 0 , M - 1} \\ {c}_{l , 1 , 0} & {c}_{l , 1 , 1} & ⋯ & {c}_{l , 1 , M - 1} \\ ⋮ & ⋮ & ⋮ & ⋮ \\ {c}_{l , L - 1 , 0} & {c}_{l , L - 1 , 1} & ⋯ & {c}_{l , L - 1 , M - 1}\end{matrix} ] {[ {b}_{0} {b}_{1} … {b}_{M - 1} ]}^{H} = [ \begin{matrix}{\sum }_{f = 0}^{M - 1} {\sum }_{i = 0}^{L - 1} {c}_{l , i , f} ( {a}_{i} {b}_{f}^{H} ) \\ {\sum }_{f = 0}^{M - 1} {\sum }_{i = 0}^{L - 1} {c}_{l , i + L , f} ( {a}_{i} {b}_{f}^{H} )\end{matrix} ] , \qquad ( Eq . 2 )$$

where
N₁ is a number of antenna ports in a first antenna port dimension (having the same antenna polarization),
N₂ is a number of antenna ports in a second antenna port dimension (having the same antenna polarization),
P_{CSI-RS} is a number of CSI-RS ports configured to the UE,
N₃ is a number of SBs for PMI reporting or number of FD units or number of FD components (that comprise the CSI reporting band) or a total number of precoding matrices indicated by the PMI (one for each FD unit/component),
aᵢ is a 2N₁N₂×1 (Eq. 1) or N₁N₂×1 (Eq. 2) column vector, and aᵢ is a N₁N₂×1 or

$$\frac{{P}_{CSIRS}}{2} \times 1$$

port selection column vector if antenna ports at the gNB are co-polarized, and is a 2N₁N₂×1 or P_{CSIRS}×1 port selection column vector if antenna ports at the gNB are dual-polarized or cross-polarized, where a port selection vector is a defined as a vector which contains a value of 1 in one element and zeros elsewhere, and P_{CSIRS} is the number of CSI-RS ports configured for CSI reporting,
b_{f} is a N₃×1 column vector,
c_{l,i,f} is a complex coefficient associated with vectors aᵢ and b_{f}.

In one example, when the UE reports a subset K<2LM coefficients (where K is either fixed, configured by the gNB or reported by the UE), then the coefficient c_{l,i,f} in precoder equations Eq. 1 or Eq. 2 is replaced with x_{l,i,f}×c_{l,i,f}, where
x_{l,i,f}=1 if the coefficient c_{l,i,f} is reported by the UE according to some embodiments of this invention.
x_{l,i,f}=0 otherwise (i.e., c_{l,i,f} is not reported by the UE). The indication whether x_{l,i,f}=1 or 0 is according to some embodiments of this invention. For example, it can be via a bitmap.

In another example, the precoder equations Eq. 1 or Eq. 2 are respectively generalized to

$${W}^{l} = {\sum }_{i = 0}^{L - 1} {\sum }_{f = 0}^{{M}_{i} - 1} {c}_{l , i , f} ( {a}_{i} {b}_{i , f}^{H} ) \qquad ( Eq . 3 )$$

$$and$$

$${W}^{l} = [ \begin{matrix}{\sum }_{i = 0}^{L - 1} {\sum }_{f = 0}^{i} {c}_{l , i , f} ( {a}_{i} {b}_{i , f}^{H} ) \\ {\sum }_{i = 0}^{L - 1} {\sum }_{= 0}^{{M}_{i} - 1} {c}_{l , i + L , f} ( {a}_{i} {b}_{i , f}^{H} )\end{matrix} ] , \qquad ( Eq . 4 )$$

where for a given i, the number of basis vectors is Mᵢ and the corresponding basis vectors are {b_{i,f}}. Note that Mᵢ is the number of coefficients c_{l,i,f} reported by the UE for a given i, where Mᵢ≤M (where {Mᵢ} or Σ Mᵢ is either fixed, configured by the gNB or reported by the UE).

The columns of W^{l} are normalized to norm one. For rank R or R layers (v=R), the pre-coding matrix is given by

$${W}^{( R )} = \frac{1}{\sqrt{R}} [ \begin{matrix}{W}^{1} & {W}^{2} & ⋯ & {W}^{R}\end{matrix} ] .$$

Eq. 2 is assumed in the rest of the disclosure. The embodiments of the disclosure, however, are general and are also application to Eq. 1, Eq. 3 and Eq. 4.

Here

$$L \leq \frac{{P}_{CSI - RS}}{2} and M \leq {N}_{3} . If L = \frac{{P}_{CSI - RS}}{2} ,$$

then A is an identity matrix, and hence not reported. Likewise, if M=N₃, then B is an identity matrix, and hence not reported. Assuming M<N₃, in an example, to report columns of B, the oversampled DFT codebook is used. For instance, b_{f}=w_{f}, where the quantity w_{f} is given by

$${w}_{f} = {[ \begin{matrix}1 & {e}^{j \frac{2 π {n}_{3 , l}^{( f )}}{{O}_{3} {N}_{3}}} & {e}^{j \frac{2 π \cdot 2 {n}_{3 , l}^{( f )}}{{O}_{3} {N}_{3}}} & … & {e}^{j \frac{2 π \cdot ( {N}_{3} - 1 ) {n}_{3 , l}^{( f )}}{{O}_{3} {N}_{3}}}\end{matrix} ]}^{T} .$$

When O₃=1, the FD basis vector for layer l ∈ {1, . . . , v} (where v is the RI or rank value) is given by

$${w}_{f} = {[ \begin{matrix}{y}_{0 , l}^{( f )} & {y}_{1 , l}^{( f )} & … & {y}_{{N}_{3} - 1 , l}^{( f )}\end{matrix} ]}^{T} ,$$

where

$${y}_{t , l}^{( f )} = {e}^{j \frac{2 π t {n}_{3 , l}^{( f )}}{{N}_{3}}}$$

and n_{3,l}=[n_{3,l}⁽⁰⁾, . . . , n_{3,l}^{(M-1)}] where n_{3,l}^{(f)} ∈ {0,1, . . . , N₃−1}.

In another example, discrete cosine transform DCT basis is used to construct/report basis B for the 3^{rd} dimension. The m-th column of the DCT compression matrix is simply given by

$${[ {W}_{f} ]}_{n m} = \{ \begin{matrix}\frac{1}{\sqrt{K}} , n = 0 \\ \sqrt{\frac{2}{K}} cos \frac{π ( 2 m + 1 ) n}{2 K} , n = 1 , … K - 1\end{matrix} ,$$

and K=N₃, and m=0, . . . , N₃−1.

Since DCT is applied to real valued coefficients, the DCT is applied to the real and imaginary components (of the channel or channel eigenvectors) separately. Alternatively, the DCT is applied to the magnitude and phase components (of the channel or channel eigenvectors) separately. The use of DFT or DCT basis is for illustration purpose only. The disclosure is applicable to any other basis vectors to construct/report A and B.

On a high level, a precoder Wₗ can be described as follows.

$$W = {A}_{l} {C}_{l} {B}_{l}^{H} = {W}_{1} {\tilde{W}}_{2} {W}_{f}^{H} , \qquad ( equation 5 )$$

where A=W₁ corresponds to the Rel. 15 W₁ in Type II CSI codebook [REF8], and B=W_{f}.

The C=\tilde{W}₂ matrix consists of all the required linear combination coefficients (e.g., amplitude and phase or real or imaginary). Each reported coefficient (c_{l,i,f}=p_{l,i,f}ϕ_{l,i,f}) in \tilde{W}₂ is quantized as amplitude coefficient (p_{l,i,f}) and phase coefficient (ϕ_{l,i,f}). In one example, the amplitude coefficient (p_{l,i,f}) is reported using a A-bit amplitude codebook where A belongs to {2, 3, 4}. If multiple values for A are supported, then one value is configured via higher layer signaling. In another example, the amplitude coefficient (p_{l,i,f}) is reported as p_{l,i,f}=p_{l,i,f}⁽¹⁾p_{l,i,f}⁽²⁾ where
p_{l,i,f}⁽¹⁾ is a reference or first amplitude which is reported using a A1-bit amplitude codebook where A1 belongs to {2, 3, 4}, and
p_{l,i,f}⁽²⁾ is a differential or second amplitude which is reported using a A2-bit amplitude codebook where A2≤A1 belongs to {2, 3, 4}.

For layer l, let us denote the linear combination (LC) coefficient associated with spatial domain (SD) basis vector (or beam) i ∈ {0, 1, . . . , 2L−1} and frequency domain (FD) basis vector (or beam) f ∈ {0, 1, . . . , M−1} as c_{l,i,f}, and the strongest coefficient as c_{l,i*,f*}. The strongest coefficient is reported out of the K_{NZ} non-zero (NZ) coefficients that is reported using a bitmap, where K_{NZ}≤K₀=┌β×2LM┐<2LM and β is higher layer configured. The remaining 2LM−K_{NZ} coefficients that are not reported by the UE are assumed to be zero. The following quantization scheme is used to quantize/report the K_{NZ} NZ coefficients.

The UE reports the following for the quantization of the NZ coefficients in \tilde{W}₂
A X-bit indicator for the strongest coefficient index (i*, f*), where X=┌log₂ K_{NZ}┐ or ┌log₂ 2L┐.
   Strongest coefficient c_{l.i*,f*}=1 (hence its amplitude/phase are not reported)
Two antenna polarization-specific reference amplitudes is used.
   For the polarization associated with the strongest coefficient c_{l,i*,f*}=1, since the reference amplitude p_{l,i,f}⁽¹⁾=1, it is not reported
   For the other polarization, reference amplitude p_{l,i,f}⁽¹⁾ is quantized to 4 bits
      The 4-bit amplitude alphabet is

$$\{ 1 , {( \frac{1}{2} )}^{\frac{1}{4}} , {( \frac{1}{4} )}^{\frac{1}{4}} , {( \frac{1}{8} )}^{\frac{1}{4}} , … , {( \frac{1}{{2}^{14}} )}^{\frac{1}{4}} \} .$$

For {c_{l,i,f}, (i, f)≠(i*, f*)}:
   For each polarization, differential amplitudes p_{l,i,f}⁽²⁾ of the coefficients calculated relative to the associated polarization-specific reference amplitude and quantized to 3 bits
      The 3-bit amplitude alphabet is

$$\{ 1 , \frac{1}{\sqrt{2}} , \frac{1}{2} , \frac{1}{2 \sqrt{2}} , \frac{1}{4} , \frac{1}{4 \sqrt{2}} , \frac{1}{8} , \frac{1}{8 \sqrt{2}} \} .$$

Note: The final quantized amplitude p_{l,i,f} is given by p_{l,i,f}⁽¹⁾×p_{l,i,f}⁽²⁾
Each phase is quantized to either 8PSK (Nₚₕ=8) or 16PSK (Nₚₕ=16) (which is configurable).

For the polarization r* ∈ {0, 1} associated with the strongest coefficient c_{l,i*,f*}, we have

$${r}^{*} = ⌊ \frac{{i}^{*}}{L} ⌋$$

and the reference amplitude p_{l,i,f}⁽¹⁾=p_{l,r*}⁽¹⁾=1. For the other polarization r ∈ {0, 1} and r≠r*, we have

$$r = ( ⌊ \frac{{i}^{*}}{L} ⌋ + 1 )$$

mod 2 and the reference amplitude p_{l,i,f}⁽¹⁾=p_{l,r}⁽¹⁾ is quantized (reported) using the 4-bit amplitude codebook mentioned above.

A UE can be configured to report M FD basis vectors. In one example,

$$M = ⌈ p \times \frac{{N}_{3}}{R} ⌉ ,$$

where R is higher-layer configured from {1, 2} and p is higher-layer configured from

$$\{ \frac{1}{4} , \frac{1}{2} \} .$$

In one example, the p value is higher-layer configured for rank 1-2 CSI reporting. For rank>2 (e.g., rank 3-4), the p value (denoted by v₀) can be different. In one example, for rank 1-4, (p, v₀) is jointly configured from

$$\{ ( \frac{1}{2} , \frac{1}{4} ) , ( \frac{1}{4} , \frac{1}{4} ) , ( \frac{1}{4} , \frac{1}{8} ) \} ,$$

i.e.,

$$M = ⌈ p \times \frac{{N}_{3}}{R} ⌉$$

for rank 1-2 and

$$M = ⌈ {v}_{0} \times \frac{{N}_{3}}{R} ⌉$$

for rank 3-4. In one example, N₃=N_{SB}×R where N_{SB} is the number of SBs for CQI reporting.

A UE can be configured to report M FD basis vectors in one-step from N₃ basis vectors freely (independently) for each layer l ∈ {0, 1, . . . , v−1} of a rank v CSI reporting. Alternatively, a UE can be configured to report M FD basis vectors in two-step as follows.
In step 1, an intermediate set (InS) comprising N₃′<N₃ basis vectors is selected/reported, wherein the InS is common for all layers.
In step 2, for each layer l ∈ {0, 1, . . . , v−1} of a rank v CSI reporting, M FD basis vectors are selected/reported freely (independently) from N₃′ basis vectors in the InS.

In one example, one-step method is used when N₃≤19 and two-step method is used when N₃>19. In one example, N₃′=┌αM┐ where α>1 is either fixed (to 2 for example) or configurable.

The codebook parameters used in the DFT based frequency domain compression (eq. 5) are (L, p, v₀, β, α, Nₚₕ). In one example, the set of values for these codebook parameters are as follows.
L: the set of values is {2, 4} in general, except L ∈ {2, 4, 6} for rank 1-2, 32 CSI-RS antenna ports, and R=1.
p for rank 1-2, and (p, v₀) for rank 3-4: p ∈

$$\{ \frac{1}{4} , \frac{1}{2} \}$$

and (p, v₀) ∈

$$\{ ( \frac{1}{2} , \frac{1}{4} ) , ( \frac{1}{4} , \frac{1}{4} ) , ( \frac{1}{4} , \frac{1}{8} ) \} .$$

$$β ∈ \{ \frac{1}{4} , \frac{1}{2} , \frac{3}{4} \} . \\ α ∈ \{ 1.5 , 2 , 2.5 , 3 \} \\ {N}_{p h} ∈ \{ 8 , 16 \} .$$

In another example, the set of values for the codebook parameters (L, p, v₀, β, α, Nₚₕ) are as follows: α=2, Nₚₕ=16, and as in Table 4, where the values of L, β and pᵥ are determined by the higher layer parameter paramCombination-r17. In one example, the UE is not expected to be configured with paramCombination-r17 equal to
3, 4, 5, 6, 7, or 8 when P_{CSI-RS}=4,
7 or 8 when number of CSI-RS ports P_{CSI-RS}<32,
7 or 8 when higher layer parameter typeII-RI-Restriction-r17 is configured with rᵢ=1 for any i>1,
7 or 8 when R=2.

The bitmap parameter typeII-RI-Restriction-r17 forms the bit sequence r₃, r₂, r₁, r₀ where r₀ is the LSB and r₃ is the MSB. When rᵢ is zero, i ∈ {0, 1, . . . , 3}, PMI and RI reporting are not allowed to correspond to any precoder associated with v=i+1 layers. The parameter R is configured with the higher-layer parameter numberOfPMISubbandsPerCQISubband-r17. This parameter controls the total number of precoding matrices N₃ indicated by the PMI as a function of the number of subbands in csi-ReportingBand, the subband size configured by the higher-level parameter subbandSize and of the total number of PRBs in the bandwidth part.

TABLE 4

| | | P_{ν} | | |
|---|---|---|---|---|
| paramCombination-r17 | L | ν ϵ {1, 2} | ν ϵ {3, 4} | β |
| 1 | 2 | ¼ | 1/8 | ¼ |
| 2 | 2 | ¼ | 1/8 | ½ |
| 3 | 4 | ¼ | 1/8 | ¼ |
| 4 | 4 | ¼ | 1/8 | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

The above-mentioned framework (equation 5) represents the precoding-matrices for multiple (N₃) FD units using a linear combination (double sum) over 2L SD beams and Mᵥ FD beams. This framework can also be used to represent the precoding-matrices in time domain (TD) by replacing the FD basis matrix W_{f} with a TD basis matrix Wₜ, wherein the columns of Wₜ comprises Mᵥ TD beams that represent some form of delays or channel tap locations. Hence, a precoder W^{l} can be described as follows.

$$W = {A}_{l} {C}_{l} {B}_{l}^{H} = {W}_{1} {\tilde{W}}_{2} {W}_{t}^{H} , \qquad ( equation 5 A )$$

In one example, the Mᵥ TD beams (representing delays or channel tap locations) are selected from a set of N₃ TD beams, i.e., N₃ corresponds to the maximum number of TD units, where each TD unit corresponds to a delay or channel tap location. In one example, a TD beam corresponds to a single delay or channel tap location. In another example, a TD beam corresponds to multiple delays or channel tap locations. In another example, a TD beam corresponds to a combination of multiple delays or channel tap locations.

This disclosure is applicable to both space-frequency (equation 5) and space-time (equation 5A) frameworks.

In general, for layer l=0, 1, . . . , v−1, where v is the rank value reported via RI, the pre-coder (cf. equation 5 and equation 5A) includes the codebook components summarized in Table 5.

TABLE 5
Codebook Components

| Index | Components | Description |
|---|---|---|
| 0 | L | number of SD beams |
| 1 | M_{ν} | number of FD/TD beams |
| 2 | {aᵢ}ᵢ₌₀^{L-1} | set of SD beams comprising |
| | | columns of Aₗ |
| 3 | {b_{l,f}}_{f=0}^{M}^{ᵥ}⁻¹ | set of FD/TD beams comprising |
| | | columns of Bₗ |
| 4 | {x_{l,i,f}} | bitmap indicating the indices of |
| | | the non-zero (NZ) coefficients |
| 5 | SCIₗ | Strongest coefficient indicator |
| | | for layer l |
| 6 | {p_{l,i,f}} | amplitudes of NZ coefficients |
| | | indicated via the bitmap |
| 7 | {ϕ_{l,i,f}} | phases of NZ coefficients |
| | | indicated via the bitmap |

In this disclosure, several high-resolution codebook design alternatives for D-MIMO antenna structure are proposed, wherein the design is based on Type II or Type II port selection or enhanced Type II or enhanced Type II port selection.

In one example, the antenna architecture of a D-MIMO system is structured. For example, the antenna structure at each RRH is dual-polarized (single or multi-panel as shown in FIG. 11. The antenna structure at each RRH can be the same. Alternatively, the antenna structure at an RRH can be different from another RRH. Likewise, the number of ports at each RRH can be the same. Alternatively, the number of ports of one RRH can be different from another RRH.

In another example, the antenna architecture of a D-MIMO system is unstructured. For example, the antenna structure at one RRH can be different from another RRH.

We assume a structured antenna architecture in this disclosure.

In one embodiment I.1, a UE is configured with a D-MIMO codebook (e.g., via higher layer signaling) which has a triple-stage pre-coder structure (for each layer). The N₃ pre-coders for a layer can be represented as W=W₁\tilde{W}₂W_{f}^{H} where the component W₁ is used to report/indicate a spatial domain (SD) basis matrix comprising SD basis vectors, the component W_{f} is used to report/indicate a frequency domain (FD) basis matrix comprising FD basis vectors, and the component \tilde{W}₂ is used to report/indicate coefficients corresponding to SD and FD basis vector pairs.

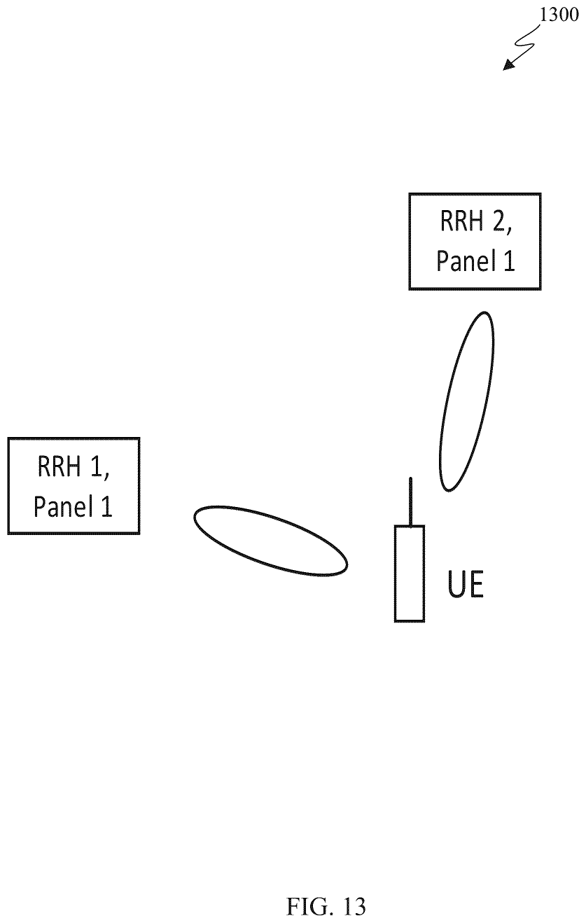

FIG. 13 illustrates an example D-MIMO 1300 where each RRH has a single antenna panel according to embodiments of the present disclosure. The embodiment of the D-MIMO 1300 where each RRH has a single antenna panel illustrated in FIG. 13 is for illustration only. FIG. 13 does not limit the scope of this disclosure to any particular implementation of the D-MIMO 1300 where each RRH has a single antenna panel.

As illustrated in FIG. 13, in one embodiment I.2, each RRH has a single antenna panel. The component W₁ has a block diagonal structure comprising X diagonal blocks, where 1 (co-pol) or 2 (dual-pol) diagonal blocks are associated with each RRH.

In one example I.2.1, X=N_{RRH} assuming co-polarized (single polarized) antenna structure at each RRH. In one example, when N_{RRH}=2, the components W₁ is given by

$${W}_{1} = [ \begin{matrix}{B}_{1} & 0 \\ 0 & {B}_{2}\end{matrix} ]$$

where B₁ is a basis matrix for the 1^{st} RRH, and B₂ is a basis matrix for the 2^{nd} RRH. In one example, Bᵣ=[b_{r,0}, b_{r,1}, . . . , b_{r,L}_{ᵣ}₋₁] comprises Lᵣ columns or beams (or basis vectors) for r-th RRH. In one example, Lᵣ=L for all r values (RRH-common L value), for example, L ∈ {2,3,4,6}. In one example, Lᵣ can be different across RRHs (RRH-specific L value), for example, Lᵣ can take a value (fixed or configured) from {2,3,4,6}.

In one example I.2.2, X=2N_{RRH} assuming dual-polarized (cross-polarized) antenna structure at each RRH.

In one example, when N_{RRH}=2, the components W₁ is given by

$${W}_{1} = [ \begin{matrix}{B}_{1} & 0 & 0 & 0 \\ 0 & {B}_{1} & 0 & 0 \\ 0 & 0 & {B}_{2} & 0 \\ 0 & 0 & 0 & {B}_{2}\end{matrix} ]$$

where B₁ is a basis matrix for the 1^{st} RRH and is common (the same) for the two polarizations, which correspond to the first and second diagonal blocks, and B₂ is a basis matrix for the 2^{nd} RRH and is common (the same) for the two polarizations, which correspond to the third and fourth diagonal blocks. In general, (2r−1)-th and (2r)-th diagonal blocks correspond to the two antenna polarizations for the r-th RRH. In one example, Bᵣ=[b_{r,0}, b_{r,1}, . . . , b_{r,L}_{ᵣ}₋₁] comprises Lᵣ columns or beams (or basis vectors) for r-th RRH. In one example, Lᵣ=L for all r values (RRH-common L value), for example, L ∈ {2,3,4,6}. In one example, Lᵣ can be different across RRHs (RRH-specific L value), for example, Lᵣ can take a value (fixed or configured) from {2,3,4,6}.

In one example, when N_{RRH}=2, the components W₁ is given by

$${W}_{1} = [ \begin{matrix}{B}_{1} & 0 & 0 & 0 \\ 0 & {B}_{2} & 0 & 0 \\ 0 & 0 & {B}_{1} & 0 \\ 0 & 0 & 0 & {B}_{2}\end{matrix} ]$$

where B₁ is a basis matrix for the 1^{st} RRH and is common (the same) for the two polarizations, which correspond to the first and third diagonal blocks, and B₂ is a basis matrix for the 2^{nd} RRH and is common (the same) for the two polarizations, which correspond to the second and fourth diagonal blocks. In general, r-th and (r+N_{RRH})-th diagonal blocks correspond to the two antenna polarizations for the r-th RRH. In one example, Bᵣ=[b_{r,0}, b_{r,1}, . . . , b_{r,L}_{ᵣ}₋₁] comprises Lᵣ columns or beams (or basis vectors) for r-th RRH. In one example, Lᵣ=L for all r values (RRH-common L value), for example, L ∈ {2,3,4,6}. In one example, Lᵣ can be different across RRHs (RRH-specific L value), for example, Lᵣ can take a value (fixed or configured) from {2,3,4,6}.

In one example, when N_{RRH}=2, the components W₁ is given by

$${W}_{1} = [ \begin{matrix}{B}_{1 , 1} & 0 & 0 & 0 \\ 0 & {B}_{1 , 2} & 0 & 0 \\ 0 & 0 & {B}_{2 , 1} & 0 \\ 0 & 0 & 0 & {B}_{2 , 2}\end{matrix} ]$$

where B_{1,1} and B_{1,2} are basis matrices for the first and second antenna polarizations of the 1^{st} RRH, which correspond to the first and second diagonal blocks, and B_{2,1} and B_{2,2} are basis matrices for the first and second antenna polarizations of the 2^{nd} RRH, which correspond to the third and fourth diagonal blocks. In general, (2r−1)-th and (2r)-th diagonal blocks correspond to the two antenna polarizations for the r-th RRH. In one example, B_{r,p}=[b_{r,p,0}, b_{r,p,1}, . . . , b_{r,p,L}_{_{r,p}}₋₁] comprises L_{r,p} columns or beams (or basis vectors) for p-th polarization of r-th RRH. In one example, L_{r,p}=L for all r and p values (RRH-common and polarization-common L value), for example L ∈ {2,3,4,6}. In one example, L_{r,p}=Lᵣ for all p values (RRH-specific and polarization-common L value). In one example, L_{r,p}=Lₚ for all r values (RRH-common and polarization-specific L value). In one example, L_{r,p} can be different across RRHs (RRH-specific and polarization-specific L value).

In one example, when N_{RRH}=2, the components W₁ is given by

$${W}_{1} = [ \begin{matrix}{B}_{1 , 1} & 0 & 0 & 0 \\ 0 & {B}_{2 , 1} & 0 & 0 \\ 0 & 0 & {B}_{1 , 2} & 0 \\ 0 & 0 & 0 & {B}_{2 , 2}\end{matrix} ]$$

where B_{1,1} and B_{1,2} are basis matrices for the first and second antenna polarizations of the 1^{st} RRH, which correspond to the first and third diagonal blocks, and B_{2,1} and B_{2,2} are basis matrices for the first and second antenna polarizations of the 2^{nd} RRH, which correspond to the second and fourth diagonal blocks. In general, r-th and (r+N_{RRH})-th diagonal blocks correspond to the two antenna polarizations for the r-th RRH. In one example, B_{r,p}=[b_{r,p,0}, b_{r,p,1}, . . . , b_{r,p,L}_{_{r,p}}₋₁] comprises L_{r,p} columns or beams (or basis vectors) for p-th polarization of r-th RRH. In one example, L_{r,p}=L for all r and p values (RRH-common and polarization-common L value), for example L ∈ {_{2,3,4,6}}. In one example, L_{r,p}=Lᵣ for all p values (RRH-specific and polarization-common L value). In one example, L_{r,p}=Lₚ for all r values (RRH-common and polarization-specific L value). In one example, L_{r,p} can be different across RRHs (RRH-specific and polarization-specific L value).

In one example I.2.3, X=Σᵣ₌₁^{N}^{^{RRH}} aᵣ, where aᵣ=1 for co-polarized (single polarized) antenna structure at r-th RRH, and aᵣ=2 for dual-polarized (cross-polarized) antenna structure at r-th RRH.

In one example, when N_{RRH}=2, the components W₁ is given by

$${W}_{1} = [ \begin{matrix}{B}_{1} & 0 & 0 \\ 0 & {B}_{2} & 0 \\ 0 & 0 & {B}_{2}\end{matrix} ]$$

where B₁ is a basis matrix for the 1^{st} RRH, and B₂ is a basis matrix for the 2^{nd} RRH and is common (the same) for the two polarizations, which correspond to the second and third diagonal blocks.

In one example, when N_{RRH}=2, the components W₁ is given by

$${W}_{1} = [ \begin{matrix}{B}_{1} & 0 & 0 \\ 0 & {B}_{2 , 1} & 0 \\ 0 & 0 & {B}_{2 , 2}\end{matrix} ]$$

where B₁ is a basis matrix for the 1^{st} RRH, and B_{2,1} and B_{2,2} are basis matrices for the first and second antenna polarizations of the 2^{nd} RRH, which correspond to the second and third diagonal blocks.

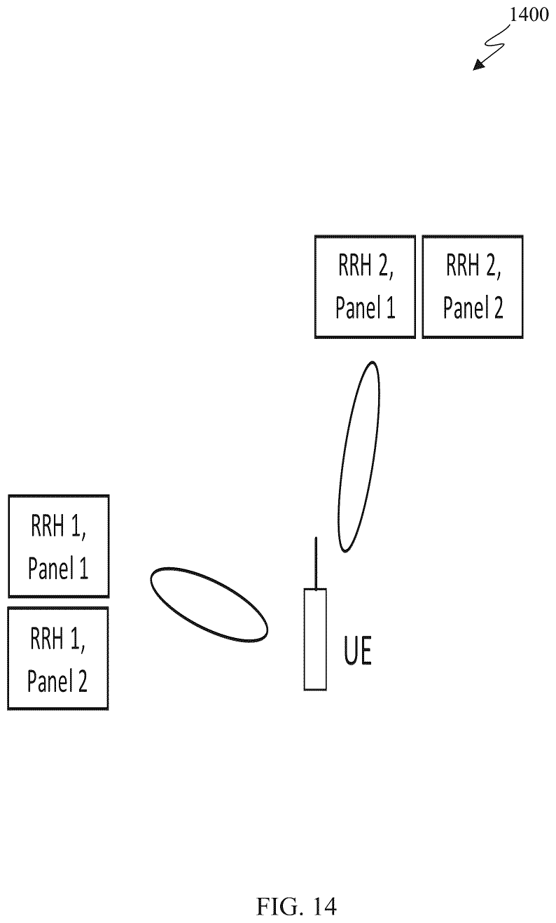

FIG. 14 illustrates an example D-MIMO 1400 where each RRH has multiple antenna panels according to embodiments of the present disclosure. The embodiment of the D-MIMO 1400 where each RRH has multiple antenna panels illustrated in FIG. 14 is for illustration only. FIG. 14 does not limit the scope of this disclosure to any particular implementation of the D-MIMO 1400 where each RRH has multiple antenna panels.

As illustrated in FIG. 14, in one embodiment I.3, each RRH has multiple antenna panels. The component W₁ has a block diagonal structure comprising X diagonal blocks, where N_{g,r} (co-pol) or 2N_{g,r} (dual-pol) diagonal blocks are associated with r-th RRH comprising N_{g,r}panels and N_{g,r}>1 for all values of r. Note N_{g,r}=2 for both RRHs in FIG. 14.

The examples in embodiment I.2 can be extended in a straightforward manner in this case (of multiple panels at RRHs) by adding the diagonal blocks corresponding to multiple panels in W₁.

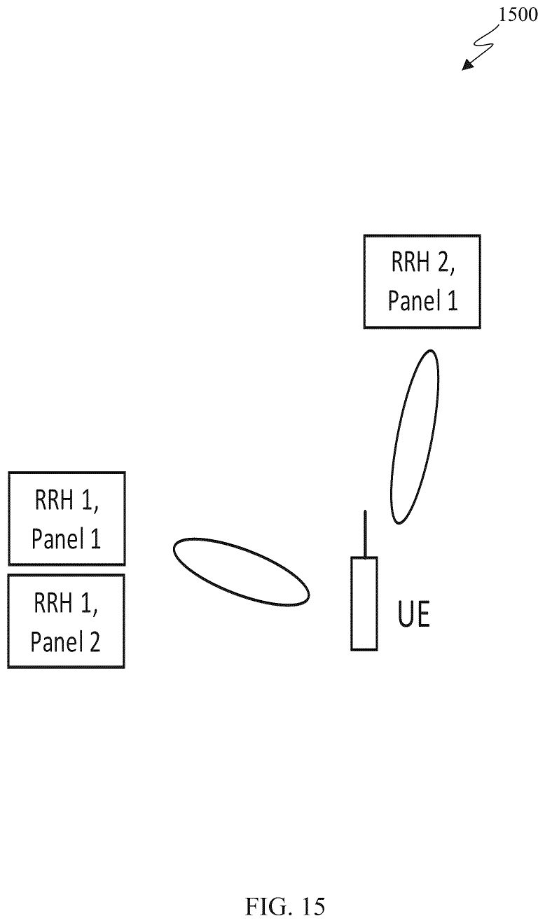

FIG. 15 illustrates an example D-MIMO 1500 where each RRH can have a single antenna panel or multiple antenna panels according to embodiments of the present disclosure. The embodiment of the D-MIMO 1500 where each RRH can have a single antenna panel or multiple antenna panels illustrated in FIG. 15 is for illustration only. FIG. 15 does not limit the scope of this disclosure to any particular implementation of the D-MIMO 1500 where each RRH can have a single antenna panel or multiple antenna panels.

As illustrated in FIG. 15, in one embodiment I.4, each RRH can have a single antenna panel or multiple antenna panels. The component W₁ has a block diagonal structure comprising X diagonal blocks, where N_{g,r} (co-pol) or 2N_{g,r} (dual-pol) diagonal blocks are associated with r-th RRH comprising N_{g,r} panels, and N_{g,r}=1 when r-th RRH has a single panel and N_{g,r}>1 when r-th RRH has multiple panels.

The examples in embodiment I.2 can be extended in a straightforward manner in this case (of multiple panels at RRHs) by adding the diagonal blocks corresponding to multiple panels in W₁.

In one embodiment I.5, the basis matrices comprising the diagonal blocks of the component W₁ have columns that are selected from a set of oversampled 2D DFT vectors. When the antenna port layout is the same across RRHs, for a given antenna port layout (N₁, N₂) and oversampling factors (O₁, O₂) for two dimensions, a DFT vector vim can be expressed as follows.

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} \\ {u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ]\end{matrix}$$

where l ∈ {0, 1, . . . , O₁N₁−1} and m ∈ {0, 1, . . . , O₂N₂−1}.

When the antenna port layout can be different across RRHs, for a given antenna port layout (N_{1,r}, N_{2,r}) and oversampling factors (O_{1,r}, O_{2,r}) associated with r-th RRH, a DFT vector Vₗ_{ᵣ}_{,m}_{ᵣ} can be expressed as follows.

$${v}_{{l}_{r} , {m}_{r}} = {[ \begin{matrix}{u}_{{m}_{r}} & {e}^{j \frac{2 π {l}_{r}}{{O}_{1 , r} {N}_{1 , r}}} {u}_{{m}_{r}} & … & {e}^{j \frac{2 π {l}_{r} ( {N}_{1 , r} - 1 )}{{O}_{1 , r} {N}_{1 , r}}} {u}_{{m}_{r}}\end{matrix} ]}^{T} \\ {u}_{{m}_{r}} = [ \begin{matrix}1 & {e}^{j \frac{2 π {m}_{r}}{{O}_{2 , r} {N}_{2 , r}}} & … & {e}^{j \frac{2 π {m}_{r} ( {N}_{2 , r} - 1 )}{{O}_{2 , r} {N}_{2 , r}}} ]\end{matrix}$$

where l, ∈ {0, 1, . . . , O_{1,r}N_{1,r}−1} and mᵣ ∈ {0, 1, . . . , O_{2,r}N_{2,r}−1}.

In one example, the oversampling factor is RRH-common, hence remains the same across RRHs. For example, e.g., O_{1,r}=O₁=O_{2,r}=O₂=4. In one example, the oversampling factor is RRH-specific, hence is independent for each RRH. For example, O_{1,r}=O_{2,r}=x and x is chosen (fixed or configured) from {2,4,8}.

In one embodiment I.6, the basis matrices comprising the diagonal blocks of the component W₁ have columns that are selected from a set of port selection vectors. When the antenna port layout is the same across RRHs, for a given number of CSI-RS port P_{CSI-RS}, a port selection vector vₘ is a P_{CSI-RS}/2-element column vector containing a value of 1 in element

$$( m mod \frac{{P}_{CSI - RS}}{2} )$$

and zeros elsewhere (where the first element is element 0).

When the antenna port layout can be different across RRHs, for a given number of CSI-RS port P_{CSI-RS,r}, a port selection vector vₘ_{ᵣ} is a P_{CSI-RS,r}/2-element column vector containing a value of 1 in element

$$( {m}_{r} mod \frac{{P}_{CSI - RS , r}}{2} )$$

and zeros elsewhere (where the first element is element 0).

In one embodiment I.7, each RRH can have a single antenna panel or multiple antenna panels (cf. FIG. 11). The component W₁ has a block diagonal structure comprising X=2 diagonal blocks, where N_{g,r} (co-pol) or 2N_{g,r} (dual-pol) diagonal blocks are associated with r-th RRH comprising N_{g,r} panels, and N_{g,r}=1 when r-th RRH has a single panel and N_{g,r}>1 when r-th RRH has multiple panels.

In one embodiment II.1, the component W_{f} is according to at least one of the following examples.

In one example II.1.1, the component W_{f} is RRH-common and layer-common, i.e., one common W_{f} is reported for all RRHs and for all layers (when number of layers or rank>1).

In one example II._{1.2}, the component W_{f} is RRH-common and layer-specific, i.e., for each layer l ∈ {1, . . . , v}, where v is a rank value or number of layers, one common W_{f} is reported for all RRHs.

In one example II.1.3, the component W_{f} is RRH-specific and layer-common, i.e., for each RRH r ∈ {1, . . . , N_{RRH}}, one common W_{f} is reported for all layers.

In one example II.1.4, the component W_{f} is RRH-specific and layer-specific, i.e., for each RRH r ∈ {1, . . . , N_{RRH}} and for each layer l ∈ {1, . . . , v}, one W_{f} is reported.

In one embodiment II.2, let W_{f} comprise Mᵥ columns for a given rank value v. The value of Mᵥ can be fixed (e.g., ½). or configured via higher layer (RRC) signaling (similar to R16 enhanced Type II codebook) or reported by the UE as part of the CSI report). The value of Mᵥ is according to at least one of the following examples.

In one example II.2.1, the value of Mᵥ is RRH-common, layer-common, and RI-common. The same Mᵥ value is used common for all values of N_{RRH}, v, and layers=1, . . . , v.

In one example II.2.2, the value of Mᵥ is RRH-common, layer-common, and RI-specific. For each RI value v, the same Mᵥ value is used common for all values of N_{RRH} and layers=1, . . . , v.

In one example II.2.3, the value of Mᵥ is RRH-common, layer-specific, and RI-common. For each layers=1, . . . , v, the same Mᵥ value is used common for all values of N_{RRH} and v.

In one example II.2.4, the value of Mᵥ is RRH-specific, layer-common, and RI-common. For each RRH r ∈ {1, . . . , N_{RRH}}, the same Mᵥ value is used common for all values of v and layers=1, . . . , v.

In one example II.2.5, the value of Mᵥ is RRH-common, layer-specific, and RI-specific.

In one example II.2.6, the value of Mᵥ is RRH-specific, layer-specific, and RI-common.

In one example II.2.7, the value of Mᵥ is RRH-specific, layer-common, and RI-specific.

In one example II.2.8, the value of Mᵥ is RRH-specific, layer-specific, and RI-specific.

In one embodiment II.3, the columns of W_{f} are selected from a set of oversampled DFT vectors. When the antenna port layout is the same across RRHs, for a given N₃ and oversampling factors O₃, a DFT vector y_{f} can be expressed as follows.

$${y}_{f} = [ \begin{matrix}1 & {e}^{j \frac{2 π f}{{O}_{3} {N}_{3}}} & … & {e}^{j \frac{2 π f ( {N}_{3} - 1 )}{{O}_{3} {N}_{3}}} ]\end{matrix}$$

where f ∈ {0, 1, . . . , O₃N₃−1}.

When the value of N₃ can be different across RRHs, for r-th RRH, a DFT vector y_{f}_{ᵣ} can be expressed as follows.

$${y}_{{f}_{r}} = [ \begin{matrix}1 & {e}^{j \frac{2 π {f}_{r}}{{O}_{3 , r} {N}_{3 , r}}} & … & {e}^{j \frac{2 π {f}_{r} ( {N}_{3} - 1 )}{{O}_{3 , r} {N}_{3 , r}}}\end{matrix} ]$$

where fᵣ ∈ {0, 1, . . . , O_{3,r}N_{3,r}−1}.

In one example, the oversampling factor is RRH-common, hence remains the same across RRHs. For example, e.g., O_{3,r}=O₃. In one example, the oversampling factor is RRH-specific, hence is independent for each RRH. For example, O_{3,r}=x and x is chosen (fixed or configured) from {1,2,4,8}. In one example, the oversampling factor=1. Then, the DFT vector y_{f} can be expressed as follows.

$${y}_{f} = [ \begin{matrix}1 & {e}^{j \frac{2 π f}{{N}_{3}}} & … & {e}^{j \frac{2 π f ( {N}_{3} - 1 )}{{N}_{3}}} ] .\end{matrix}$$

In one embodiment II.4, the columns of W_{f} are selected from a set of port selection vectors. When N₃ value is the same across RRHs, for a given N₃ value, a port selection vector vₘ is a N₃-element column vector containing a value of 1 in element (m mod N₃) and zeros elsewhere (where the first element is element 0).

When the value of N₃ can be different across RRHs, for a given N_{3,r} value, a port selection vector vₘ_{ᵣ} is a N₃-element column vector containing a value of 1 in element (mᵣ mod N₃) and zeros elsewhere (where the first element is element 0).

In one embodiment III.1, the codebook includes additional components due to N_{RRH}>1 RRHs.

In one example III.1.1, the additional components include inter-RRH phase. In one example, the inter-RRH phase values correspond to N_{RRH}−1 phase values (e.g., assuming one of the RRHs is a reference and has a fixed phase value=1). In another example, the inter-RRH phase values correspond to N_{RRH} phase values. The inter-RRH phase values can be quantized/reported as scalars using a scalar codebook (e.g., QPSK, 2 bits per phase or 8PSK, 3 bits per phase) or as a vector using a vector codebook (e.g., a DFT codebook). Also, for a dual-polarized antenna at an RRH, the inter-RRH phase can be the same for two polarizations of the RRH. Alternatively, it can be independent for two polarizations for the RRH. At least one of the following example is used for the inter-RRH phase reporting.
In one example III.1.1.1, the inter-RRH phase is reported in a wideband (WB) manner, i.e., one value is reported for all SBs in the configured CSI reporting band. Due to WB reporting, it can be included in the W₁ component of the codebook. Alternatively, it can be included in a new component, for example W₃ of the codebook.
In one example III.1.1.2, the inter-RRH phase is reported in a subband (SB) manner, i.e., one value is reported for each SB in the configured CSI reporting band. Due to SB reporting, it can be included in the W₂ component of the codebook. Alternatively, it can be included in a new component, for example W₃ of the codebook.
In one example III.1.1.3, the inter-RRH phase is reported in a WB plus SB manner, i.e., one WB phase value is reported for all SBs in the configured CSI reporting band, and one SB value is reported for each SB in the configured CSI reporting band. Due to WB plus SB reporting, the WB part can be included in the W₁ component of the codebook and the SB part can be included in the W₂ component of the codebook. Alternatively, both WB and SB parts can be included in a new component, for example W₃ of the codebook.

In one example III.1.2, the additional components include inter-RRH phase and inter-RRH amplitude, wherein the details about the inter-RRH phase are as explained in example III.1.1. Note that inter-RRH amplitude is needed due to unequal distance of the UE from RRHs. In one example, the inter-RRH amplitude values correspond to N_{RRH}−1 amplitude values (e.g., assuming one of the RRHs is a reference and has a fixed amplitude value=1). In another example, the inter-RRH amplitude values correspond to N_{RRH} amplitude values. The inter-RRH amplitude values can be quantized/reported as scalars using a scalar codebook (e.g., 2 bits per amplitude or 3 bits per amplitude) or as a vector using a vector codebook. Also, for a dual-polarized antenna at an RRH, the inter-RRH amplitude can be the same for two polarizations of the RRH. Alternatively, it can be independent for two polarizations for the RRH. At least one of the following example is used for the inter-RRH amplitude and phase reporting.
In one example III.1.2.1, the inter-RRH amplitude is reported in a wideband (WB) manner, i.e., one value is reported for all SBs in the configured CSI reporting band. Due to WB reporting, it can be included in the W₁ component of the codebook. Alternatively, it can be included in a new component, for example W₃ of the codebook. At least one of the following example is used for the inter-RRH phase.
   In one example III.1.2.1.1, the inter-RRH phase is reported is reported according to example III.1.1.1.
   In one example III.1.2.1.2, the inter-RRH phase is reported is reported according to example III.1.1.2.
   In one example III.1.2.1.3, the inter-RRH phase is reported is reported according to example III.1.1.3.
In one example III.1.2.2, the inter-RRH amplitude is reported in a subband (SB) manner, i.e., one value is reported for each SB in the configured CSI reporting band. Due to SB reporting, it can be included in the W₂ component of the codebook. Alternatively, it can be included in a new component, for example W₃ of the codebook. At least one of the following example is used for the inter-RRH phase.
   In one example III.1.2.2.1, the inter-RRH phase is reported is reported according to example III.1.1.1.
   In one example III.1.2.2.2, the inter-RRH phase is reported is reported according to example III.1.1.2.
   In one example III.1.2.2.3, the inter-RRH phase is reported is reported according to example III.1.1.3.
In one example III.1.2.3, the inter-RRH amplitude is reported in a WB plus SB manner, i.e., one WB amplitude value is reported for all SBs in the configured CSI reporting band, and one SB value is reported for each SB in the configured CSI reporting band. Due to WB plus SB reporting, the WB part can be included in the W₁ component of the codebook and the SB part can be included in the W₂ component of the codebook. Alternatively, both WB and SB parts can be included in a new component, for example W₃ of the codebook. At least one of the following example is used for the inter-RRH phase.
   In one example III.1.2.3.1, the inter-RRH phase is reported is reported according to example III.1.1.1.
   In one example III.1.2.3.2, the inter-RRH phase is reported is reported according to example III.1.1.2.
   In one example III.1.2.3.3, the inter-RRH phase is reported is reported according to example III.1.1.3.

In one example III.1.3, the additional components include inter-RRH amplitude, wherein the details about the inter-RRH amplitude are as explained in example III.1.2.

In one example III.1.4, the additional components include inter-RRH power, wherein the details about the inter-RRH power are as explained in example III.1.2 by replacing amplitude with power. In one example, a square of inter-RRH amplitude equals inter-RRH power.

In one example III.1.5, the additional components include inter-RRH phase and inter-RRH power, wherein the details about the inter-RRH phase are as explained in example III.1.1, and the details about the inter-RRH power are as explained in example III.1.2 by replacing amplitude with power. In one example, a square of inter-RRH amplitude equals inter-RRH power.

In one example III.1.6, the additional components include an indicator indicating the strongest RRH (for reference). Due to distributed architecture, the strongest RRH can be reported in order to indicate the reference RRH with respect to which the inter-RRH components (such as amplitude or/and phase) are reported. The inter-RRH amplitude and phase associated with the strongest RRH can be set to a fixed value, for example 1. At least one of the following example is used for the strongest RRH reporting.
In one example III.1.6.1, the strongest RRH (indicator) is reported in a WB manner, i.e., one value (indicator) is reported for all SBs. Due to WB reporting, it can be included in the W₁ component of the codebook. Alternatively, it can be included in a new component, for example W₃ of the codebook.
In one example III.1.6.2, the strongest RRH (indicator) is reported in a SB manner, i.e., one value (indicator) is reported for each SB. Due to SB reporting, it can be included in the W₂ component of the codebook. Alternatively, it can be included in a new component, example W₃ of the codebook.

In one example, the strongest RRH is reported in a layer-common manner, i.e., one strongest RRH is reported common for all layers when number of layers>1 (or rank>1).

In one example, the strongest RRH is reported in a layer-specific manner, i.e., one strongest RRH is reported for each layer of the number of layers when number of layers>1 (or rank>1).

The amplitude/phase associated with the strongest RRH can be fixed, e.g., to 1. In an alternate design, the strongest RRH can be configured (e.g., via RRC signaling), or can be fixed (e.g., RRH 1 is always strongest).

In one embodiment III.1.4, an RRH selection is performed wherein a subset of Z RRHs are selected from the N_{RRH} RRHs and the CSI is reported for the selected Z RRHs. In one example, the RRH selection is configured via RRC signaling. In another example, the RRH selection is performed by the UE, for example, the UE reports an indicator for this selection or reports inter-RRH amplitude=0 indicating that an RRH is not selected.

In one example, the RRH selection is performed in a layer-common manner, i.e., the RRH selection is performed common for all layers when number of layers>1 (or rank>1).

In one example, the RRH selection is performed in a layer-specific manner, i.e., the RRH selection is performed for each layer of the number of layers when number of layers>1 (or rank>1).

In one example III.1.4.1, the UE is configured with a Type II codebook (or Type II port selection) for D-MIMO (e.g., by setting RRC parameter codebookType=TypeII-D-MIMO or TypeII-PortSelection-D-MIMO), wherein the codebook includes a component for RRH selection (ON/OFF).

In one example, this component is separate (dedicated for RRH selection). For example, a bit sequence comprising N_{RRH} bits is used where each bit of the bit sequence is associated with an RRH, and the bit value ‘1’ is used to indicate that the RRH is selected and the bit value ‘0’ is used to indicate that the RRH is not selected.

In another example, this component is combined (joint) with an amplitude component of the codebook, where the amplitude codebook includes a value 0 (in addition to other values greater than 0), and the bit value ‘0’ is used to indicate/report that the RRH is not selected and the bit value greater than 0 is used to indicate/report that the RRH is selected and the indicated/reported value indicates the amplitude weighting in the precoder equation/calculation.

In one example III.1.4.2, a UE is configured to report the CSI based on the D-MIMO codebook using a two-part UCI, UCI part 1 and UCI part 2, and the UCI part 1 is used indicate/report the RRH selection. In one example, the two-part UCI is configured only when the UE is configured to report the SB CSI reporting based on the D-MIMO codebook. In one example, the two-part UCI is configured only when the UE is configured with the Type II or Type II port selection codebook for D-MIMO.

In one example III.1.4.3, a UE is configured to report the CSI based on the D-MIMO codebook using a two-part UCI, UCI part 1 and UCI part 2, and the UCI part 2 is used indicate/report the RRH selection. In one example, the two-part UCI is configured only when the UE is configured to report the SB CSI reporting based on the D-MIMO codebook. In one example, the two-part UCI is configured only when the UE is configured with the Type II or Type II port selection codebook for D-MIMO.

In this disclosure, the codebook component W₁ and W_{f} refer to pre-coder (or pre-coding matrix) components that are indicated via the components of the first PMI indicator i₁. Likewise, the codebook component \tilde{W}₂ refers to pre-coder (or pre-coding matrix) components that are indicated via the components of the second PMI indicator i₂. Likewise, the new codebook component W₃ refers to pre-coder (or pre-coding matrix) components that are indicated via the components of the third PMI indicator i₃.

In one embodiment IV.1, the other components of the codebook are similar to Rel. 16 enhanced Type II codebook.

In one example, IV.1.1, a bitmap is used to indicate the location (or indices) of the non-zero coefficients of the \tilde{W}₂ matrix. In one example, this bitmap is common for all layers, i.e., one bitmap is reported for all layers. In another example, this bitmap is layer-specific, i.e., one bitmap is reported for each layer value.

In one example, IV.1.2, a strongest coefficient indicator (SCI) is used to indicate the location (or index) of the strongest coefficient of the \tilde{W}₂ matrix. In one example, the SCI is common for all layers, i.e., one SCI is reported for all layers. In another example, the SCI is layer-specific, i.e., one SCI is reported for each layer value.

In example, IV.1.3, amplitude and phase of the non-zero coefficients of the \tilde{W}₂ matrix are reported using respective codebooks. In one example, the phase codebook is fixed, e.g., 16PSK. In one example, the phase codebook is configured, e.g., from 8PSK (3-bit per phase) and 16PSK (4-bit per phase).

In one example, the amplitude codebook is fixed, e.g., to a 4-bit codebook as shown below.

4-bit amplitude codebook: k_{l,p}⁽¹⁾ to p_{l,p}⁽¹⁾

| k_{l,p}⁽¹⁾ | p_{l,p}⁽¹⁾ |
|---|---|
| 0 | 0 |
| 1 | $\frac{1}{\sqrt{128}}$ |
| 2 | ${( \frac{1}{8192} )}^{1 / 4}$ |
| 3 | 1/8 |
| 4 | ${( \frac{1}{2048} )}^{1 / 4}$ |
| 5 | $\frac{1}{2 \sqrt{8}}$ |
| 6 | ${( \frac{1}{512} )}^{1 / 4}$ |
| 7 | 1/4 |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | 1/2 |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

In one example, the amplitude codebook is fixed, e.g., to a 3-bit codebook as shown below.

3-bit amplitude codebook: k_{l,i,f}⁽²⁾ to p_{l,i,f}⁽²⁾

| k_{l,i,f}⁽²⁾ | p_{l,i,f}⁽²⁾ |
|---|---|
| 0 | 0 |
| 1 | 1/8 |
| 2 | $\frac{1}{4 \sqrt{2}}$ |
| 3 | 1/4 |
| 4 | $\frac{1}{2 \sqrt{2}}$ |
| 5 | 1/2 |
| 6 | $\frac{1}{\sqrt{2}}$ |
| 7 | 1 |

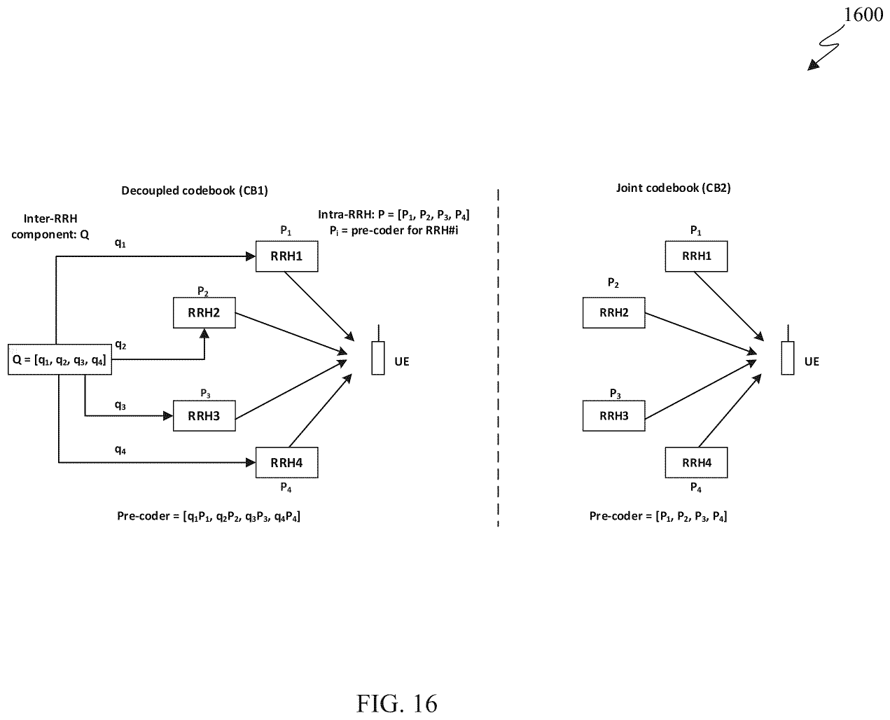

FIG. 16 illustrates codebooks for D-MIMO 1600 according to embodiments of the present disclosure. The embodiment of the codebooks for D-MIMO 1600 illustrated in FIG. 16 is for illustration only. FIG. 16 does not limit the scope of this disclosure to any particular implementation of the codebooks for D-MIMO 1600.

As illustrated in FIG. 16, in one embodiment V.1, the codebook (CB) for this distributed setting can be decoupled (CB1) or joint (CB2). For CB1, the codebook comprises intra-and inter-RRH components, intra-for antenna ports within each RRH and inter-for antenna ports across multiple RRHs. For CB2, the codebook comprises components for all antenna ports aggregated across RRHs. The components of the codebook can be low-resolution (e.g., Type I codebook in 5G NR) or high-resolution (e.g., Type II codebook in 5G NR) or a combination of low-resolution and high-resolution components. For high-resolution, the 5G NR supports both the codebook without any frequency domain (FD) compression (Rel. 15 Type II codebook) or with FD compression (Rel. 16 Type II codebook). The later achieves large reduction in CSI overhead while maintaining approximately the same user perceived throughout (UPT) as the former; hence is more attractive for UE implementations.

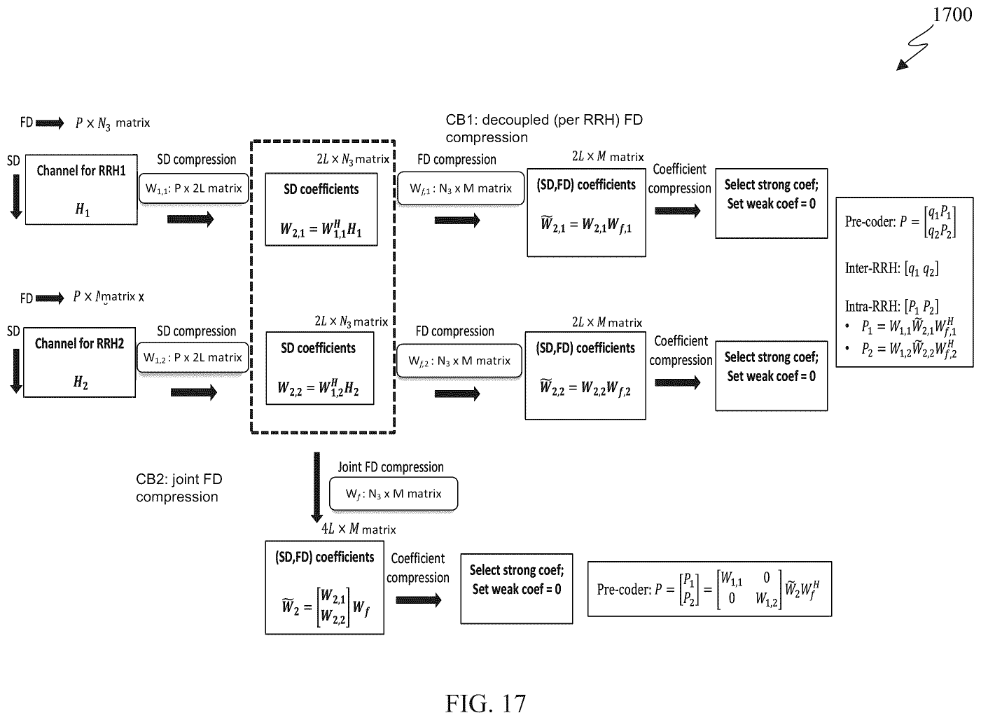

FIG. 17 illustrates example decoupled and joint codebooks 1700 based on spatial- and frequency-domain compression according to embodiments of the present disclosure. The embodiment of the decoupled and joint codebooks 1700 illustrated in FIG. 17 is for illustration only. FIG. 17 does not limit the scope of this disclosure to any particular implementation of the decoupled and joint codebooks 1700.

For CSI reporting, both decoupled and joint high-resolution codebooks across multiple RRHs can be considered. For decoupled codebook (CB1), the intra-RRH components are based on Rel-16 enhanced Type II (e-TypeII) codebook for each RRH, and the inter-RRH components comprise inter-RRH amplitude (power) and phase. For the joint codebook (CB2), a modified Rel-16 e-TypeII codebook is considered wherein the spatial domain (SD) compression is performed per RRH and the ‘joint’ frequency domain (FD) compression is performed across RRHs. The high-level design principle of the two codebooks is illustrated in FIG. 17 (assuming 2 RRHs). There are three key components:
W₁: selection of 2L SD basis vectors, each P×1, and P is the number of SD dimensions (e.g., antenna ports).
W_{f}: selection of M FD basis vectors, each N₃×1, and N₃ is the number of FD dimensions (e.g., subbands)
\tilde{W}₂: selection of K₀ strongest (SD, FD) combining coefficients, and quantization of amplitude and phase of the selected coefficients, where K₀=β2LM and β<1 is the coefficient compression factor.

The compression is achieved via all three components: P to 2L in SD dimensions, N₃ to M in FD dimensions, and 2LM to K₀ in combining coefficients. While SD and FD dimension reduction achieves some compression, the large compression is achieved via coefficient compression. The overhead compression is approximately

$$\frac{β \times {N}_{RRH} \times 2 LM}{{PN}_{3}} .$$

For the decoupled codebook (CB1), the three components are obtained for each RRH separately, which determine the intra-RRH component [P₁, . . . P_{N}_{_{RRH}}], which are multiplied with the respective inter-RRH component from [q₁, . . . q_{N}_{_{RRH}}] to obtain the final pre-coder. For the joint codebook (CB2), the SD compression component is obtained for each RRH separately (similar to CB1), then the resultant SD coefficient matrices (after SD compression) are concatenated together (across all RRHs) to perform joint FD compression and coefficient compression.

When rank (or number of layers)>1, the compression is performed independently for each layer. In one example, W₁ can be common for all layers or independent for each layer, W_{f} is independent for each layer, and \tilde{W}₂ is independent for each layer. The CSI reporting comprises at least three components, pre-coding matrix indicator (PMI), rank indicator (RI), and CQI. The components of the codebook are reported via PMI, the rank value is reported via RI, and the channel quality is reported via CQI.

Referring back to FIG. 9, the system illustrated therein utilizes multiple analog beams for transmission and reception (wherein one or a small number of analog beams are selected out of a large number, for instance, after a training duration—to be performed from time to time), so the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system illustrated in FIG. 9 is also applicable to higher frequency bands such as >52.6 GHz (also termed the FR4). In this case, the system can employ only analog beams. Due to the O2 absorption loss around 60 GHz frequency (˜10 dB additional loss @100 m distance), larger number of and sharper analog beams (hence larger number of radiators in the array) will be needed to compensate for the additional path loss.

At lower frequency bands such as FR1 or particularly sub-1 GHz band, on the other hand, the number of antenna elements cannot be increased in a given form factor due to large wavelength. As an example, for the case of the wavelength size (λ) of the center frequency 600 MHz (which is 50 cm), it requires 4 m for uniform-linear-array (ULA) antenna panel of 16 antenna elements with the half-wavelength distance between two adjacent antenna elements. Considering a plurality of antenna elements is mapped to one digital port in practical cases, the required size for antenna panels at gNB to support a large number of antenna ports, e.g., 32 CSI-RS ports, becomes very large in such low frequency bands, and it leads to the difficulty of deploying 2-D antenna arrays within the size of a conventional form factor. This can result in a limited number of physical antenna elements and, subsequently CSI-RS ports, that can be supported at a single site and limit the spectral efficiency of such systems.

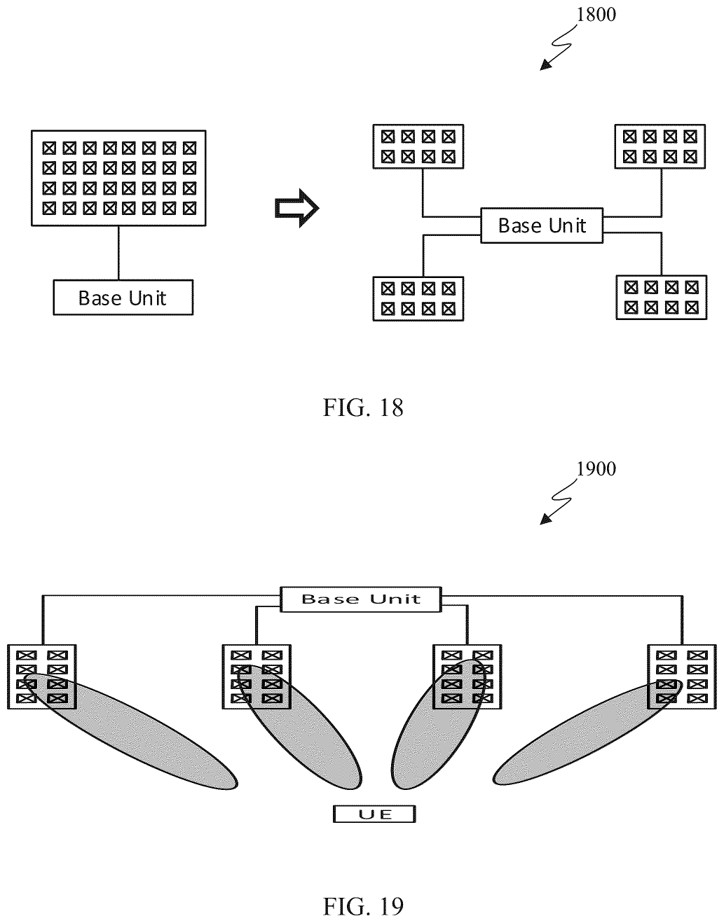

FIG. 18 illustrates an example system for D-MIMO 1800 according to embodiments of the present disclosure. The embodiment of the example system for D-MIMO 1800 illustrated in FIG. 18 is for illustration only. FIG. 18 does not limit the scope of this disclosure to any particular implementation of the example system for D-MIMO 1800.

As illustrated in FIG. 18, one approach to resolve the issue described above is to form multiple antenna panels (e.g., antenna modules, RRHs) with a small number of antenna ports instead of integrating all of the antenna ports in a single panel (or at a single site) and to distribute the multiple panels in multiple locations/sites (or RRHs), as illustrated in FIG. 18.

FIG. 19 illustrates an example system for D-MIMO 1900 according to embodiments of the present disclosure. The embodiment of the example system for D-MIMO 1900 illustrated in FIG. 19 is for illustration only. FIG. 19 does not limit the scope of this disclosure to any particular implementation of the example system for D-MIMO 1900.

As illustrated in FIG. 19, the multiple antenna panels at multiple locations can still be connected to a single base unit, and thus the signal transmitted/received via multiple distributed panels can be processed in a centralized manner through the single base unit. In another embodiment, it is possible that multiple distributed antenna panels are connected to more than one base units, which communicates with each other and jointly supporting single antenna system. Although there is no restriction on the placement of multiple antenna panels of distributed MIMO system, it is also possible that some (or all) of multiple antenna panels can be collocated, for example, on a same building/stadium. In cases that multiple antenna panels are collocated (or even in the case that panels are not collocated), channel coefficients across the panels can have a certain level of correlation, and this can be exploited in CSI codebook design to compress the amount of CSI feedback for distributed MIMO.

In another embodiment, this disclosure proposes a new codebook structure with a panel domain basis to effectively compress channel coefficients to report for antenna panels/RRHs of distributed MIMO. Although we use the terminology ‘a panel domain’ in this disclosure, it can be extended to or applied to any other domain (e.g., a third dimension domain in addition to SD and FD domains). In one example, a Doppler domain can be applied in embodiments of this disclosure.

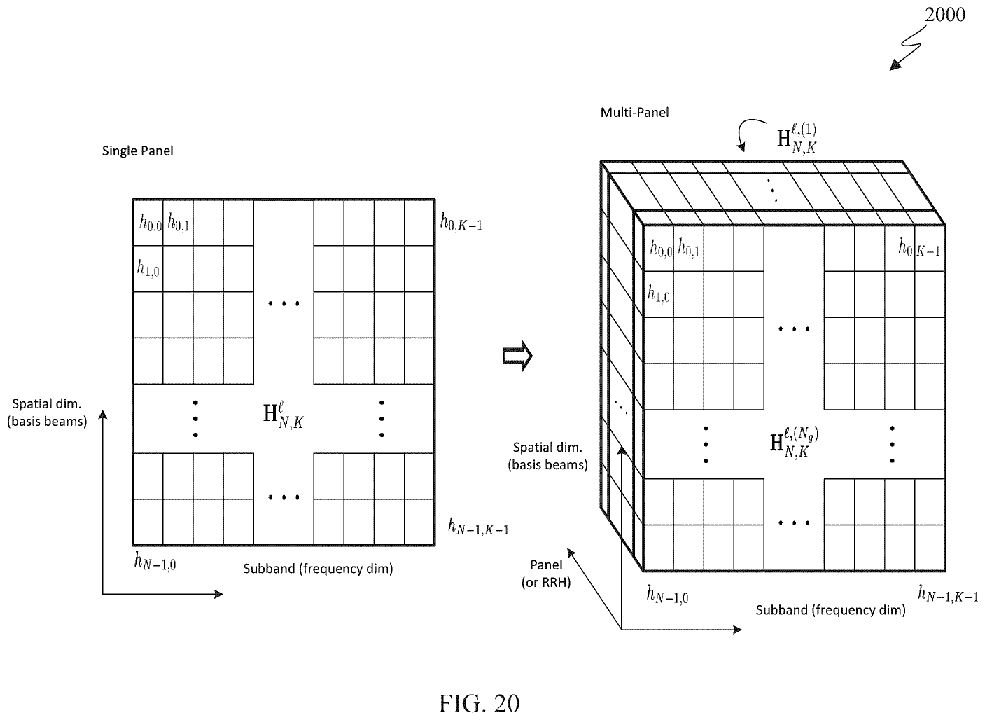

FIG. 20 illustrates an example of DL channels for single panel and multi-panel cases 2000 according to embodiments of the present disclosure. The embodiment of the example of DL channels for single panel and multi-panel cases 2000 illustrated in FIG. 20 is for illustration only. FIG. 20 does not limit the scope of this disclosure to any particular implementation of the example of DL channels for single panel and multi-panel cases system for D-MIMO 2000.

Compared to the case of single panel (or single-RRH, single antenna module/block), there is one more dimension that can be compressed for CSI reporting in the case of multi-panel (or multi-RRH, multiple antenna modules/blocks) MIMO system. FIG. 20 shows an illustration of DL channels for single panel and multi-panel cases, respectively. For DL channels of the multi-panel case, it can be expressed as [symbol] for a given layer [symbol] . Here, N, K, and N_{g} are the numbers of antenna ports, subbands, and panels (or RRHs), respectively. In one example, N=2N₁N₂ for dual-polarized case. In another example, N=N₁N₂ for single-polarized case.

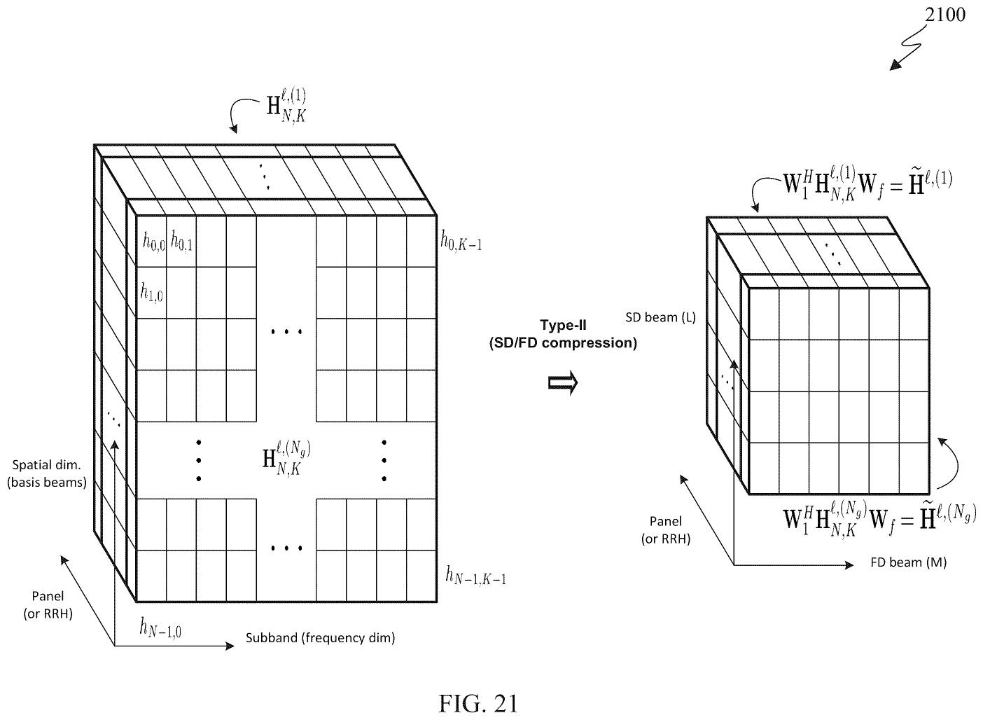

FIG. 21 illustrates an example of compression using the SD/FD basis beams 2100 according to embodiments of the present disclosure. The embodiment of the example of compression using the SD/FD basis beams 2100 illustrated in FIG. 21 is for illustration only. FIG. 21 does not limit the scope of this disclosure to any particular implementation of the example of compression using the SD/FD basis beams 2100.

As shown on the left of FIG. 21 (or on the right of FIG. 20)), since the three dimensions of spatial, subband, and panel domains are available, CSI reporting can be further compressed by introducing a basis for panel domain in addition to spatial and frequency domains (that are being used to compress in Rel-15/16/17 CSI codebook).

Assuming that spatial and frequency domains are compressed using the SD/FD basis beams, i.e., the precoder structure of W^{l}=W₁\tilde{W}₂W_{f}^{H} for a given layer [symbol] , as in Type-II codebook [9], the three dimensional channel coefficients can be expressed as

$${W}_{1}^{H} {H}_{N , K}^{ℓ , ( {n}_{g} )} {W}_{f} {=}^{Δ} {\tilde{H}}^{ℓ , ( {n}_{g} )} , for {n}_{g} = 1 , 2 , … , {N}_{g}$$

where \tilde{H} [symbol] ^{,(n}^{_{g}}⁾ is the L×M coefficient matrix for the n_{g}-th panel, and W₁ and W_{f} are N×L and M×K basis matrices for spatial domain and frequency domain, respectively. FIG. 8 shows an illustration of the compression using the SD/FD basis beams, i.e., via Type-II compression [9]. In one example, \tilde{H} [symbol] ^{,(i)} can be quantized using the \tilde{W}₂ codebook as in Type-II codebook [9] and can be reported panel-specifically (RRH-specifically). In this case, however, the amount of feedback will linearly increase with respect to the number of panels N_{g}, that is O(N_{g}LM), and thus it can increase the uplink channel overhead for CSI reporting.

One way to compress the amount of feedback in a multi-panel (or RRH) framework is to introduce another basis for panel domain and to exploit the correlation among the panels to reduce the dimension of panel domain using the basis.

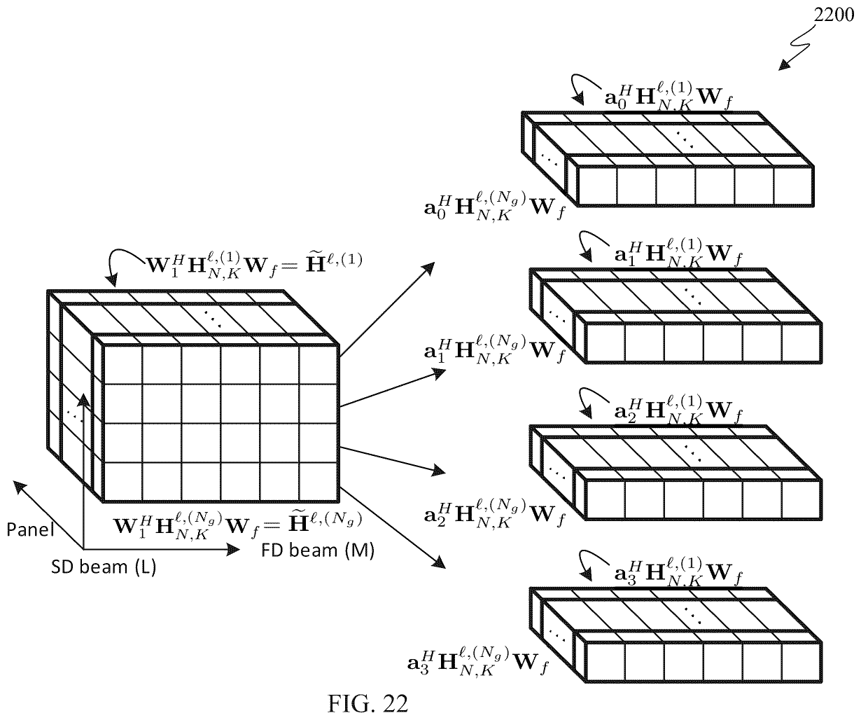

FIG. 22 illustrates an example of restructuring to form a matrix over the FD-PD plane for each SD basis beam 2200 according to embodiments of the present disclosure. The embodiment of the example of restructuring to form a matrix over the FD-PD plane for each SD basis beam 2200 illustrated in FIG. 22 is for illustration only. FIG. 22 does not limit the scope of this disclosure to any particular implementation of the example of restructuring to form a matrix over the FD-PD plane for each SD basis beam 2200.

In one embodiment VI, a UE is configured with a multi-panel codebook (or D-MIMO codebook) which includes a basis matrix for panel domain. The structure of the multi-panel codebook consists of W₁, W_{f}, W_{P}, and W₃, and the precoder for a given layer [symbol] for panel n_{g} can be represented as

$${}^{, ( {n}_{g} )} = {W}_{1} {\tilde{W}}_{2}^{( {n}_{g} )} {W}_{f}^{H} = {W}_{1} ( {I}_{L} ⊗ {e}_{{N}_{g ,} {n}_{g}}^{H} ) {W}_{P} {W}_{3} {W}_{f}^{H} , for all {n}_{g} = 1 , 2 … , {N}_{g} \qquad ( Eq . 6 )$$

where the component W₁ is a N-by-L matrix and is used to indicate/report a spatial domain (SD) basis matrix comprising SD basis vectors, the component W_{f} is a K-by-M matrix and is used to indicate/report a frequency domain (FD) basis matrix comprising FD basis vectors, the component W_{P} is an LN_{g}-by-LU matrix and is used to indicate/report a panel domain (PD) basis (or multiple PD bases) comprising PD basis vectors, and the component W₃ is an LU-by-M matrix and is used to indicate/report coefficients corresponding to the SD/FD/PD vector tuples in the above form. Here, I_{L} is the L-by-L identity matrix, and e_{N}_{_{g}}_{,n}_{_{g}} is the N_{g}-dimensional (column) vector containing one for the n_{g}-element and all zeros elsewhere, and ⊗ is the Kronecker product, and thus (I_{L}⊗e_{N}_{_{g}}_{,n}_{_{g}}^{H}) is a deterministic matrix, and hence not reported.

The underlying principle of the codebook structure of (Eq. 6) is illustrated in FIG. 22. The coefficient matrices corresponding to SD and FD basis vector pairs for all panel n_{g}=1, 2, . . . , N_{g}, i.e., { [symbol] ^{,(n}^{_{g}}⁾}ₙ_{_{g}}₌₁^{N}^{_{g}}, can be restructured to form a matrix over the FD-PD plane for a given SD basis beam as shown in FIG. 22. That is, for a given SD beam i, the restructured matrix over the FD-PD plane can be represented as

$${\tilde{H}}_{FD - PD , i}^{ℓ} = [ \begin{matrix}{a}_{i}^{H} {H}_{N , K}^{ℓ , ( 1 )} {W}_{f} \\ {a}_{i}^{H} {H}_{N , K}^{ℓ , ( 2 )} {W}_{f} \\ ⋮ \\ {a}_{i}^{H} {H}_{N , K}^{ℓ , ( {N}_{g} )} {W}_{f}\end{matrix} ] ,$$

where aᵢ is the i-th column vector of the SD basis matrix W₁. The column vectors of the restructured matrix [symbol] _{FD-PD,i} can be correlated, and thus the restructured matrix [symbol] _{FD-PD,i} can be further compressed (in terms of CSI reporting) by decomposing a PD basis matrix G and corresponding coefficient matrix \tilde{C} in a smaller dimension than the original form of [symbol] _{FD-PD,i}. In one example, [symbol] _{FD-PD,i}=Gᵢ\tilde{C}ᵢ, where Gᵢ is a N_{g}-by-U basis matrix with U≤N_{g} and \tilde{C}ᵢ is a U-by-M coefficient matrix for a given SD beam i. Using Gᵢ and \tilde{C}ₗ, W_{P} and W₃ can be represented as,

$${W}_{P} = [ \begin{matrix}{G}_{1} & 0 & 0 & 0 \\ 0 & {G}_{2} & 0 & 0 \\ 0 & 0 & ⋱ & 0 \\ 0 & 0 & 0 & {G}_{L}\end{matrix} ]$$

and

$${W}_{3} = [ \begin{matrix}{\tilde{C}}_{1} \\ {\tilde{C}}_{2} \\ ⋮ \\ {\tilde{C}}_{L}\end{matrix} ] ,$$

respectively.

In one embodiment VII.1, the component W_{P} is composed of a same PD basis matrix over the FD-PD plane for all SD basis beams. For example, it can be represented as

$${W}_{P} = {I}_{L} ⊗ G = [ \begin{matrix}G & 0 & 0 & 0 \\ 0 & G & 0 & 0 \\ 0 & 0 & ⋱ & 0 \\ 0 & 0 & 0 & G\end{matrix} ]$$

where G=[g₀, g₁, . . . , g_{U}] is a N_{g}-by-U PD basis matrix. This is the case that a common PD basis matrix is applied to all channel coefficient matrices over the FD-PD plane for all SD basis beams.

In one embodiment VII.2, the component W_{P} is composed of a different PD basis matrix over the FD-PD plane for each SD basis beam. For example, it can be represented as

$${W}_{P} = [ \begin{matrix}{G}_{1} & 0 & 0 & 0 \\ 0 & {G}_{2} & 0 & 0 \\ 0 & 0 & ⋱ & 0 \\ 0 & 0 & 0 & {G}_{L}\end{matrix} ]$$

where Gᵢ=[g_{i,0}, g_{i,1}, . . . , g_{i,U}] is a N_{g}-by-U PD basis matrix for i=1, . . . , L. This is the case that a specific PD basis matrix is applied to each channel coefficient matrix over the FD-PD plane for each SD basis beam.

In another example, Gᵢ=[g_{i,0}, g_{i,1}, . . . , g_{i,U}_{ᵢ}] is a N_{g}-by-Uᵢ PD basis matrix for i=1, . . . , L. That is the case that a specific PD basis matrix can have a different number of basis vectors.

In one embodiment VII.3, the component W_{P} is composed of a same PD basis matrix over the FD-PD plane for all SD basis beams in each SD-basis beam group, where SD-basis beam groups are partitions of the set of all SD-basis beams. For example, it can be represented as

$${W}_{P} = [ \begin{matrix}{G}_{{X}_{1}} & 0 & 0 & 0 \\ 0 & {G}_{{X}_{1}} & 0 & 0 \\ 0 & 0 & ⋱ & 0 \\ 0 & 0 & 0 & {G}_{{X}_{P}}\end{matrix} ]$$

where G_{X}_{ᵢ}=[g_{X}_{ᵢ}_{,0}, g_{X}_{ᵢ}_{,1}, . . . , g_{X}_{ᵢ}_{,U}] is a N_{g}-by-U PD basis matrix. This is the case that a common (or group-specific) PD basis matrix is applied to all of the channel coefficient matrices over the FD-PD plane for all SD basis beams within the same SD-basis beam group.

In another example, G_{X}_{ᵢ}=[g_{X}_{ᵢ}_{,0}, 9_{X}_{ᵢ}_{,1}, . . . , g_{X}_{ᵢ}_{,U}_{_{Xi}}] is a N_{g}-by-U_{X}_{ᵢ} PD basis matrix for different Xᵢ. This is the case that a group-specific PD basis matrix can have a different number of basis vectors.

In one embodiment VII.4, the PD basis matrices that are diagonal matrices of W_{P} are selected from a set of oversampled DFT vectors. In one example, for a given N_{g} and oversampled factor O₄, a DFT vector pᵢ can be expressed as

$${p}_{i} = [ \begin{matrix}\begin{matrix}\begin{matrix}1 & {e}^{j \frac{2 π i}{{O}_{4} {N}_{g}}}\end{matrix} & …\end{matrix} & {{e}^{j \frac{2 π i ( {N}_{g} - 1 )}{{O}_{4} {N}_{g}}} ]}^{T} ,\end{matrix}$$

where i ∈ {0, 1, . . . , O₄N_{g}−1}.

In one embodiment VII.5, the PD basis matrices that are diagonal matrices of W_{P} are selected from a set of panel/RRH/antenna module selection vectors.

In one embodiment VIII.1, the coefficient component W₃ is composed of U-by-M \tilde{C}₁, . . . , \tilde{C}_{L} coefficient matrices.

In one embodiment VIII.2, the coefficient component W₃ is composed of {\tilde{C}ₗ}ₗ₌₁^{L} coefficient matrices each of which has Uₗ-by-M dimension.

In one embodiment VIII.3, the coefficient component W₃ is composed of {\tilde{C}ₗ}ₗ₌₁^{L} coefficient matrices each of which belongs to a group Xᵢ and has U_{X}_{ᵢ}-by-M dimension, where Xᵢ refers to the one in embodiment VII.3.

In one embodiment VIII.4, each element of \tilde{C}ₗ is decomposed into amplitude and phase values, and they are selected from different quantized codebooks. In one example, they can be designed similar to the codebooks for \tilde{W}₂ in Rel-16 codebook.

In one example VIII.4.1, a bitmap is used to indicate the location (or indices) of the non-zero coefficients of the \tilde{C}ₗ matrix.

In one example VIII.4.2, a strongest coefficient indicator (SCI) is used to indicate the location (or index) of the strongest coefficient of the \tilde{C}ₗ matrix.

In example VIII.4.3, amplitude and phase of the non-zero coefficients of the \tilde{C}ₗ matrix are reported using respective codebooks. In one example, the phase codebook is fixed, e.g., 16PSK. In one example, the phase codebook is configured, e.g., from 8PSK (3-bit per phase) and 16PSK (4-bit per phase).

In one embodiment IX, a UE is configured with a multi-panel codebook (or D-MIMO codebook) which includes a basis matrix for panel domain. The structure of the multi-panel codebook consists of W₁, W_{f}, W_{P}, and W₃, and the precoder for a given layer [symbol] for panel n_{g} can be represented as

$${, ( {n}_{g} )}^{} = \text{} {W}_{1} {\tilde{W}}_{2}^{( {n}_{g} )} {W}_{f}^{H} = {W}_{1} {( ( {I}_{M} ⊗ {e}_{{N}_{g ,} {n}_{g}}^{H} ) {W}_{P} {W}_{3} )}^{H} \text{} {W}_{f}^{H} , for all {n}_{g} = 1 , \text{} 2 … , {N}_{g} \qquad ( Eq . 7 )$$

where the component W₁ is a N-by-L matrix and is used to indicate/report a spatial domain (SD) basis matrix comprising SD basis vectors, the component W_{f} is a K-by-M matrix and is used to indicate/report a frequency domain (FD) basis matrix comprising FD basis vectors, the component W_{P} is an MN_{g}-by-MU matrix and is used to indicate/report a panel domain (PD) basis (or multiple PD bases) comprising PD basis vectors, and the component W₃ is an MU-by-L matrix and is used to indicate/report coefficients corresponding to the SD/FD/PD vector tuples in the above form. Here, I_{M} is the M-by-M identity matrix, and e_{N}_{_{g}}_{,n}_{_{g}} is the N_{g}-dimensional (column) vector containing one for the n_{g}-element and all zeros elsewhere, and ⊗ is the Kronecker product, and thus (I_{M}⊗e_{N}_{_{g}}_{,n}_{_{g}}^{H}) is a deterministic matrix, and hence not reported.

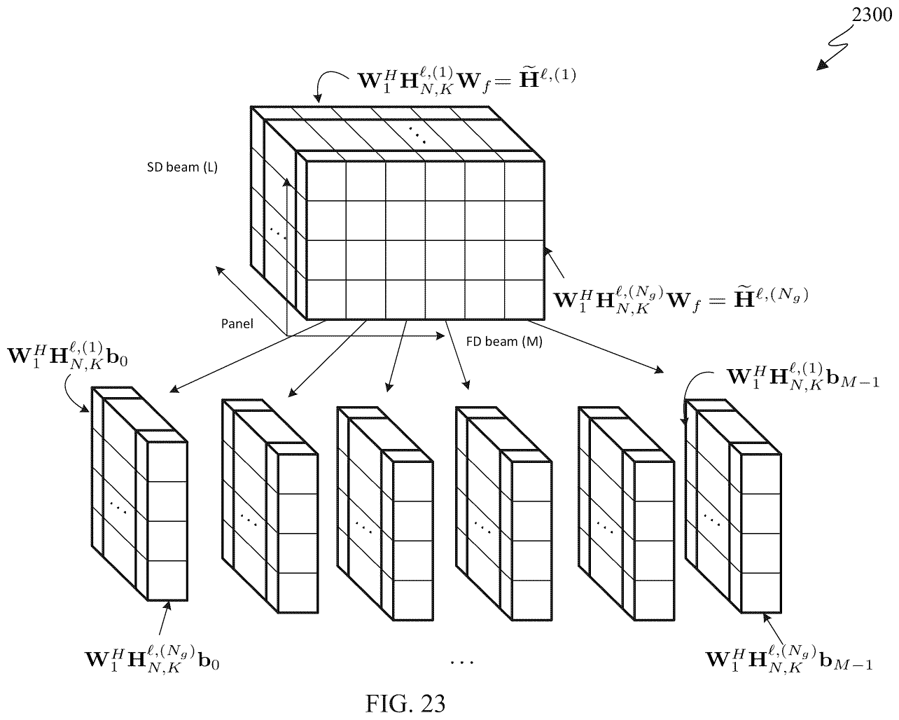

FIG. 23 illustrates an example of restructuring to form a matrix over the SD-PD plane for each FD basis beam 2300 according to embodiments of the present disclosure. The embodiment of the example of restructuring to form a matrix over the SD-PD plane for each FD basis beam 2300 illustrated in FIG. 23 is for illustration only. FIG. 23 does not limit the scope of this disclosure to any particular implementation of the example of restructuring to form a matrix over the SD-PD plane for each FD basis beam 2300.

The underlying principle of the codebook structure of (Eq. 7) is illustrated in FIG. 23. The coefficient matrices corresponding to SD and FD basis vector pairs for all panel n_{g}=1, 2, . . . , N_{g}, i.e., { [symbol] ^{,(n}^{_{g}}⁾}ₙ_{_{g}}₌₁^{N}^{_{g}}, can be restructured to form a matrix over the SD-PD plane for a given FD basis beam as shown in FIG. 10. That is, for a given FD beam j, the restructured matrix over the SD-PD plane can be represented as

$${\tilde{H}}_{SD - PD , j}^{ℓ} = [ \begin{matrix}{W}_{1}^{H} {H}_{N , K}^{ℓ , ( 1 )} {b}_{j} \\ {W}_{1}^{H} {H}_{N , K}^{ℓ , ( 2 )} {b}_{j} \\ ⋮ \\ {W}_{1}^{H} {H}_{N , K}^{ℓ , ( {N}_{g} )} {b}_{j}\end{matrix} ] ,$$

where bⱼ is the j-th column vector of the FD basis matrix W_{f}. The column vectors of the restructured matrix [symbol] _{SD-PD,j} can be correlated, and thus the restructured matrix [symbol] _{SD-PD,j} can be further compressed (in terms of CSI reporting) by decomposing a PD basis matrix G and corresponding coefficient matrix \tilde{C} in a smaller dimension than the original form of [symbol] _{SD-PD,j}. In one example, [symbol] _{SD-PD,j}=Gⱼ\tilde{C}ⱼ, where Gⱼ is a N_{g}-by-U basis matrix with U≤N_{g} and \tilde{C}ⱼ is a U-by-L coefficient matrix for a given FD beam j. Using Gⱼ and [symbol] , W_{P} and W₃ can be represented as,

$${W}_{P} = [ \begin{matrix}{G}_{1} & 0 & 0 & 0 \\ 0 & {G}_{2} & 0 & 0 \\ 0 & 0 & ⋱ & 0 \\ 0 & 0 & 0 & {G}_{M}\end{matrix} ]$$

and

$${W}_{3} = [ \begin{matrix}{\tilde{C}}_{1} \\ {\tilde{C}}_{2} \\ ⋮ \\ {\tilde{C}}_{M}\end{matrix} ] ,$$

respectively.

In one embodiment X.1, the component W_{P} is composed of a same PD basis matrix over the SD-PD plane for all FD basis beams. For example, it can be represented as

$${W}_{P} = {I}_{M} ⊗ G = [ \begin{matrix}G & 0 & 0 & 0 \\ 0 & G & 0 & 0 \\ 0 & 0 & ⋱ & 0 \\ 0 & 0 & 0 & G\end{matrix} ]$$

where G=[g₀, g₁, . . . , g_{U}] is a N_{g}-by-U PD basis matrix. This is the case that a common PD basis matrix is applied to all channel coefficient matrices over the SD-PD plane for all FD basis beams.

In one embodiment X.2, the component W_{P} is composed of a different PD basis matrix over the SD-PD plane for each FD basis beam. For example, it can be represented as

$${W}_{P} = [ \begin{matrix}{G}_{1} & 0 & 0 & 0 \\ 0 & {G}_{2} & 0 & 0 \\ 0 & 0 & ⋱ & 0 \\ 0 & 0 & 0 & {G}_{M}\end{matrix} ]$$

where Gⱼ=[g_{j,0}, g_{j,1}, . . . , g_{j,U}] is a N_{g}-by-U PD basis matrix for j=1, . . . , M. This is the case that a specific PD basis matrix is applied to each channel coefficient matrix over the SD-PD plane for each FD basis beam.

In another example, Gⱼ=[g_{j,0}, g_{j,1}, . . . , g_{j,U}_{ⱼ}] is a N_{g}-by-Uⱼ PD basis matrix for j=1, . . . , M. That is the case that a specific PD basis matrix can have a different number of basis vectors.

In one embodiment X.3., the component W_{P} is composed of a same PD basis matrix over the SD-PD plane for all FD basis beams in each FD-basis beam group, where FD-basis beam groups are partitions of the set of all FD-basis beams. For example, it can be represented as

$${W}_{P} = [ \begin{matrix}{G}_{{X}_{1}} & 0 & 0 & 0 \\ 0 & {G}_{{X}_{1}} & 0 & 0 \\ 0 & 0 & ⋱ & 0 \\ 0 & 0 & 0 & {G}_{{X}_{P}}\end{matrix} ]$$

where G_{X}_{ⱼ}=[g_{X}_{ⱼ}_{,0}, g_{X}_{ⱼ}_{,1}, . . . , g_{X}_{ⱼ}_{,U}] is a N_{g}-by-U PD basis matrix. This is the case that a common (or group-specific) PD basis matrix is applied to all of the channel coefficient matrices over the SD-PD plane for all FD basis beams within the same FD-basis beam group.

In another example, G_{X}_{ⱼ}=[g_{X}_{ⱼ}_{,0}, g_{X}_{ⱼ}_{,1}, . . . , g_{X}_{ⱼ}_{,U}_{_{Xj}}] is a N_{g}-by-U_{X}_{ⱼ} PD basis matrix for different Xⱼ. This is the case that a group-specific PD basis matrix can have a different number of basis vectors.

In one embodiment X.4, the PD basis matrices that are diagonal matrices of W_{P} are selected from a set of oversampled DFT vectors. In one example, for a given N_{g} and oversampled factor O₄, a DFT vector pᵢ can be expressed as

$${p}_{i} = {[ \begin{matrix}\begin{matrix}\begin{matrix}1 & {e}^{j \frac{2 π i}{{O}_{4} {N}_{g}}}\end{matrix} & …\end{matrix} & {e}^{j \frac{2 π i ( {N}_{g} - 1 )}{{O}_{4} {N}_{g}}}\end{matrix} ]}^{T} ,$$

where i ∈ {0, 1, . . . , O₄N_{g}−1}.

In one embodiment X.5, the PD basis matrices that are diagonal matrices of W_{P} are selected from a set of panel/RRH/antenna module selection vectors.

In one embodiment XI.1, the coefficient component W₃ is composed of U-by-L \tilde{C}₁, . . . , \tilde{C}_{M} coefficient matrices.

In one embodiment XI.2, the coefficient component W₃ is composed of {\tilde{C}ₘ}ₘ₌₁^{M} coefficient matrices each of which has Uₗ-by-L dimension.

In one embodiment XI.3, the coefficient component W₃ is composed of {\tilde{C}ₘ}ₘ₌₁^{M} coefficient matrices each of which belongs to a group Xᵢ and has U_{X}_{ᵢ}-by-L dimension, where Xᵢ refers to the one in embodiment X.3.

In one embodiment XI.4, each element of \tilde{C}ₘ is decomposed into amplitude and phase values, and they are selected from different quantized codebooks. In one example, they can be designed similar to the codebook for \tilde{W}₂ in Rel-15/16/17 codebook.

In one example XI.4.1, a bitmap is used to indicate the location (or indices) of the non- zero coefficients of the \tilde{C}ₘ matrix.

In one example XI.4.2, a strongest coefficient indicator (SCI) is used to indicate the location (or index) of the strongest coefficient of the \tilde{C}ₘ matrix.

In one example XI.4.3, amplitude and phase of the non-zero coefficients of the \tilde{C}ₘ matrix are reported using respective codebooks. In one example, the phase codebook is fixed, e.g., 16PSK. In one example, the phase codebook is configured, e.g., from 8PSK (3-bit per phase) and 16PSK (4-bit per phase).

In one embodiment XII.1, the component W₁ is similar to the one in Rel-16 (enhanced) Type II codebook.

In one embodiment XII.2, the component W₁ is the N-by-N identity matrix, which implies there is no compression in SD domain. In one example, the FD-PD compression is performed per each port index in SD domain.

In one embodiment XII.3, the component W_{f} is similar to the one in Rel-16 (enhanced) Type II codebook.

In one embodiment XII.4, the component W_{f} is the K-by-K identity matrix, which implies there is no compression in FD domain. In one example, the SD-PD compression is performed per each subband index in FD domain.

Any of the above variation embodiments can be utilized independently or in combination with at least one other variation embodiment.

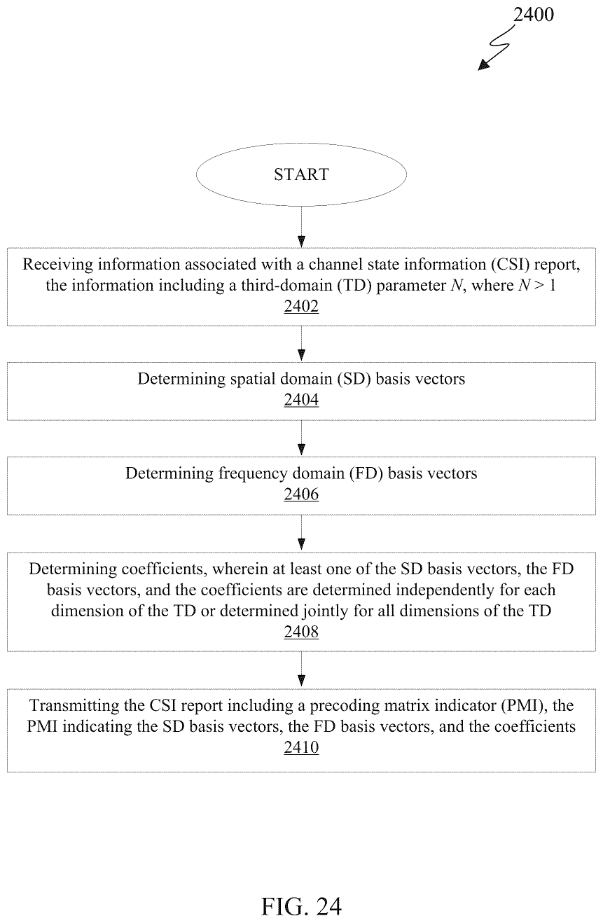

FIG. 24 illustrates a flow chart of a method 2400 for operating a user equipment (UE), as may be performed by a UE such as UE 116, according to embodiments of the present disclosure. The embodiment of the method 2400 illustrated in FIG. 24 is for illustration only. FIG. 24 does not limit the scope of this disclosure to any particular implementation.

As illustrated in FIG. 24, the method 2400 begins at step 2402. In step 2402, the UE (e.g., 111-116 as illustrated in FIG. 1) receives information associated with a channel state information (CSI) report, the information including a third-domain (TD) parameter N̅, where N̅>1.

In step 2404, the UE determines spatial domain (SD) basis vectors.

In step 2406, the UE determines frequency domain (FD) basis vectors.

In step 2408, the UE determines coefficients; wherein at least one of the SD basis vectors, the FD basis vectors, and the coefficients are determined independently for each dimension of the TD or determined jointly for all dimensions of the TD.

In step 2410, the UE transmits the CSI report including a precoding matrix indicator (PMI), the PMI indicating the SD basis vectors, the FD basis vectors, and the coefficients.

In one embodiment, the TD parameter corresponds to a number of radio remote heads (RRHs), and the UE determines both the SD basis vectors and the FD basis vectors independently for each of the RRHs.

In one embodiment, the UE determines the coefficients corresponding to (SD, FD) basis vector pairs independently for each of the RRHs, and determines an inter-RRH amplitude and an inter-RRH phase for each of the RRHs excluding a strongest RRH, wherein the strongest RRH is determined based on channel qualities of the RRHs, and the CSI report further includes an indicator indicating the strongest RRH.

In one embodiment, the TD parameter corresponds to a number of RRHs, and the UE determines the SD basis vectors independently for each of the RRHs; and determines the FD basis vectors that are common for all of the RRHs.

In one embodiment, the UE determines the coefficients corresponding to (SD, FD) basis vector pairs independently for each of the RRHs, using the common FD basis vectors across all of the RRHs.

In one embodiment, the UE determines TD basis vectors; determines the coefficients corresponding to (SD, FD, TD) basis vector tuples, and the PMI further indicates the TD basis vectors.

In one embodiment, the UE determines the TD basis vectors independently for an FD-TD coefficient matrix for each of the SD basis vectors, where the FD-TD coefficient matrix includes coefficients associated with all FD basis vectors, all TD dimensions, and a fixed SD basis vector; or determines the TD basis vectors commonly for all FD-TD coefficient matrices, wherein each FD-TD coefficient matrix includes coefficients associated with all FD basis vectors, all TD dimensions, and a fixed SD basis vector.

In one embodiment, the UE determines the TD basis vectors independently for an SD-TD coefficient matrix for each of the FD basis vectors, where the SD-TD coefficient matrix includes coefficients associated with all SD basis vectors, all TD dimensions, and a fixed FD basis vector; or determines the TD basis vectors commonly for all SD-TD coefficient matrices, wherein each SD-TD coefficient matrix includes coefficients associated with all SD basis vectors, all TD dimensions, and a fixed FD basis vector.

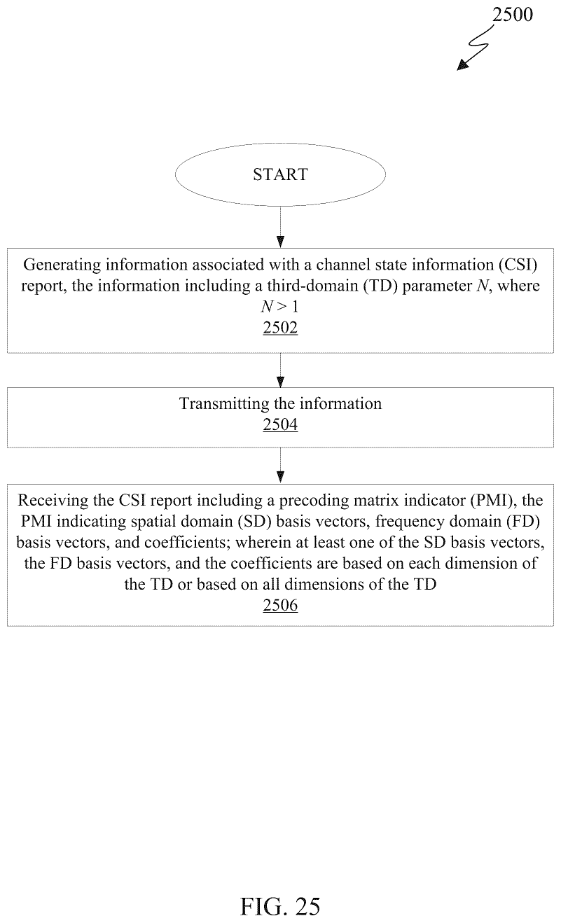

FIG. 25 illustrates a flow chart of another method 2500, as may be performed by a base station (BS) such as BS 102, according to embodiments of the present disclosure. The embodiment of the method 2500 illustrated in FIG. 25 is for illustration only. FIG. 25 does not limit the scope of this disclosure to any particular implementation.

As illustrated in FIG. 25, the method 2500 begins at step 2502. In step 2502, the BS (e.g., 101-103 as illustrated in FIG. 1), generates information associated with a channel state information (CSI) report, the information including a third-domain (TD) parameter N̅, where N̅>1.

In step 2504, the BS transmits the information.

In step 2506 the BS receives the CSI report including a precoding matrix indicator (PMI), the PMI indicating spatial domain (SD) basis vectors, frequency domain (FD) basis vectors, and coefficients; wherein at least one of the SD basis vectors, the FD basis vectors, and the coefficients are based on each dimension of the TD or based on all dimensions of the TD.

In one embodiment, the TD parameter corresponds to a number of radio remote heads (RRHs), and both the SD basis vectors and the FD basis vectors are determined independently for each of the RRHs.

In one embodiment, the coefficients corresponding to (SD, FD) basis vector pairs are determined independently for each of the RRHs, an inter-RRH amplitude and an inter-RRH phase are determined for each of the RRHs excluding a strongest RRH, where the strongest RRH is determined based on channel qualities of the RRHs, and the CSI report further includes an indicator indicating the strongest RRH.

In one embodiment, the TD parameter corresponds to a number of RRHs, the SD basis vectors are determined independently for each of the RRHs, and the FD basis vectors that are common for all of the RRHs are determined.

In one embodiment, the coefficients corresponding to (SD, FD) basis vector pairs are determined independently for each of the RRHs, using the common FD basis vectors across all of the RRHs.

In one embodiment, TD basis vectors are determined, the coefficients corresponding to (SD, FD, TD) basis vector tuples are determined, and the PMI further indicates the TD basis vectors.

In one embodiment, the TD basis vectors are determined independently for an FD-TD coefficient matrix for each of the SD basis vectors, where the FD-TD coefficient matrix includes coefficients associated with all FD basis vectors, all TD dimensions, and a fixed SD basis vector; or the TD basis vectors are determined commonly for all FD-TD coefficient matrices, wherein each FD-TD coefficient matrix includes coefficients associated with all FD basis vectors, all TD dimensions, and a fixed SD basis vector.

In one embodiment, the TD basis vectors are determined independently for an SD-TD coefficient matrix for each of the FD basis vectors, where the SD-TD coefficient matrix includes coefficients associated with all SD basis vectors, all TD dimensions, and a fixed FD basis vector; or the TD basis vectors are determined commonly for all SD-TD coefficient matrices, wherein each SD-TD coefficient matrix includes coefficients associated with all SD basis vectors, all TD dimensions, and a fixed FD basis vector.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to:
receive, from a base station (BS), first information configuring a channel state information (CSI), report, wherein the first information indicates a codebook type for the CSI report as a type II coherent transmission, and
receive, from the BS, second information configuring a plurality of CSI reference signal (CSI-RS) resource for the CSI report; and
a controller operably coupled with the transceiver, the controller configured to:
identify a first vector for each CSI-RS resource of the plurality of CSI-RS resources, and
identify a second vector being common for the plurality of CSI-RS resources,
wherein the transceiver is further configured to transmit, to the BS, the CSI report including a precoding matrix indicator (PMI) identified based on the first vector and the second vector.

2. The UE of claim 1, wherein the CSI report further includes a phase value for each CSI-RS resource of the plurality of CSI-RS resources.

3. The UE of claim 1, wherein the first vector is a 2 dimensional discrete Fourier transform (DFT) vector and identified based on oversampling factors for a first dimension and a second dimension.

4. The UE of claim 1, wherein:
a number of antenna ports for each transmission and reception point (TRP) of a plurality of TRPs is same, and
the plurality of TRPs correspond to the plurality of CSI-RS resources.

5. A base station (BS) in a wireless communication system, the BS comprising:
a controller; and
a transceiver operably coupled with the controller, the transceiver configured to:
transmit, to a user equipment (UE), first information configuring a channel state information (CSI) report, wherein the first information indicates a codebook type for the CSI report as a type II coherent transmission,
transmit, to the UE, second information configuring a plurality of CSI reference signal (CSI-RS) resource for the CSI report, and
receive, from the UE, the CSI report including a precoding matrix indicator (PMI) identified based on a first vector and a second vector,
wherein the first vector is for each CSI-RS resource of the plurality of CSI-RS resources, and
wherein the second vector is common for the plurality of CSI-RS resources.

6. The BS of claim 5, wherein the CSI report further includes a phase value for each CSI-RS resource of the plurality of CSI-RS resources.

7. The BS of claim 5, wherein the first vector is a 2 dimensional discrete Fourier transform (DFT vector and identified based on oversampling factors for a first dimension and a second dimension.

8. The BS of claim 5, wherein:
a number of antenna ports for each transmission and reception point (TRP) of a plurality of TRPs is same, and
the plurality of TRPs correspond to the plurality of CSI-RS resources.

9. A method performed by a user equipment (UE) in a wireless communication system, the method comprising:
receiving, from a base station (BS), first information configuring a channel state information (CSI) report, wherein the first information indicates a codebook type for the CSI report as a type II coherent transmission;
receiving, from the BS, second information configuring a plurality of CSI reference signal (CSI-RS) resource for the CSI report;
identifying a first vector for each CSI-RS resource of the plurality of CSI-RS resources;
identifying a second vector being common for the plurality of CSI-RS resources; and
transmitting, to the BS, the CSI report including a precoding matrix indicator (PMI) identified based on the first vector and the second vector.

10. The method of claim 9, wherein the CSI report further includes a phase value for each CSI-RS resource of the plurality of CSI-RS resources.

11. The method of claim 9, wherein the first vector is a 2 dimensional discrete Fourier transform (DFT) vector and identified based on oversampling factors for a first dimension and a second dimension.

12. The method of claim 9, wherein:
a number of antenna ports for each transmission and reception point, TRP, of a plurality of TRPs is same, and
the plurality of TRPs correspond to the plurality of CSI-RS resources.
